(19) United States
(12) Patent Application Publication
(10) Pub. No.: US 2025/0341062 A1
(43) Pub. Date: Nov. 6, 2025

(54) SPORTS FIELD WITH SHOCK PAD

(71) Applicant: ROCKWOOL A/S, Hedehusene (DK)

(72) Inventors: Linda DE VRIES, Hedehusene (DK); Dorte BARTNIK JOHANSSON, Hedehusene (DK); Miroslav NIKOLIC, Hedehusene (DK)

(21) Appl. No.: 18/259,842

(22) PCT Filed: Oct. 1, 2021
(86) PCT No.: PCT/EP2021/077194

§ 371 Date: Jun. 29, 2023

(30) Foreign Application Priority Data
Dec. 30, 2020 (WO) PCT/EP2020/088061

(51) Int. Cl. E01C 13/08

(52) U.S. Cl. CPC E01C 13/08; E01C 2201/10; E01C 2201/16; E01C 2201/20

(57) ABSTRACT

The present invention relates to a sports field comprising:
(i) a lower base layer;
(ii) an upper grass and/or artificial grass layer;
(iii) a shock pad layer, positioned between the base layer and the grass or artificial grass layer;
wherein the shock pad layer comprises at least one shock pad comprising a coherent plate having upper and lower major surfaces, wherein the coherent plate comprises at least one coherent layer comprising man-made vitreous fibres (MMVF) bonded with a cured aqueous binder composition free of phenol and formaldehyde; wherein the aqueous binder composition prior to curing comprises:
   a component (i) in form of one or more lignosulfonate lignins having a carboxylic acid group content of 0.03 to 1.4 mmol/g, based on the dry weight of the lignosulfonate lignins,
   a component (ii) in form of one or more cross-linkers.

### FIELD OF THE INVENTION

The invention relates to a sports field comprising a shock pad, and a method of producing a sports field. The invention also relates to a shock pad and use of a shock pad for absorbing shock in sports fields.

### BACKGROUND OF THE INVENTION

It is known to include shock pads in sports fields, especially artificial grass fields for team-based sports such as hockey or football (soccer). Typically, sports fields must meet specific requirements for performance, durability and construction. For example, in order for sports to be played in a consistent manner, sports fields must comply with a set of standards for features such as shock absorption, energy restitution, ball rebound, ball roll, ball deviation and impact response. International governing bodies of sports (e.g. FIFA for football and FIH for hockey) set out specific requirements, which sports fields must meet in order to be officially approved.

Shock pads are used in sports fields, in particular artificial fields, to meet the above-described standards. Shock pads increase the durability of sports fields, whilst also providing the required spring for playing sports. Shock pads can also be used to prevent injuries by absorbing shock or impact. They are typically an essential part of any artificial playing field.

WO 04/033194A1 discloses an underpad system for artificial sports fields. The purpose of the underpad is to provide an effective and safe playing field for sports such as soccer. The underpad comprises three layers made from foam, rubber or plastic.

WO 2013/060634 A1 discloses a shock pad for artificial playing fields. The purpose of the shock pad is to improve shock absorption and energy restitution characteristics of the artificial turf systems. The shock pad comprises a three-dimensional entangled mat of extruded filaments made from thermoplastic elastomeric polymer.

WO 87/07520 A1 discloses an underlay shock pad for use in playgrounds and other areas where there is a risk of children falling. The purpose of the shock pad is to prevent head injuries in children who fall. The shock pad consists of a mineral wool slab of 30 to 300 mm, having a density of 70 to 300 kg/m³. However, this shock pad would not be suitable for use in artificial playing fields, as it would not meet the set of strict requirements; it is designed instead for playgrounds.

It would be desirable to produce a shock pad that meets the specific playing field requirements set by international governing bodies of sports, such as FIFA and FIH, but is made from a material that is more sustainable and environmentally friendly than existing foam, rubber, plastic or polymeric shock pads.

It would be desirable to produce a shock pad that is less sensitive to temperature conditions in comparison to existing foam, rubber, plastic or polymeric shock pads.

It is also a requirement of sports fields, in particular artificial sports fields, that a suitable drainage system and a flood prevention system are put in place. It is important that all surface water be removed from the sports pitch at a rate which will avoid surface flooding. It is known to manufacture shock pads so that they allow water to drain through into draining systems, since it would be undesirable for shock pads to prevent the drainage system from working effectively. It would be desirable to produce a shock pad that meets the specific playing field requirements set by international governing bodies of sports, such as FIFA and FIH, but which prevents or treats flooding and therefore results in the same performance level under all weather conditions.

A problem that exists with artificial sports fields is that they can become extremely hot in certain weather conditions. For example, surface temperatures may become as high as 90° C. under certain climatic conditions (with natural turfs having a maximum temperature of 30-40° C.). This is undesirable for the general area in which the artificial sports field is located, as it increases air conditioning costs and thus peak summertime energy demand. This is also undesirable for players as the surface emits heat during play, which is uncomfortable, and can result in injuries (for example, heat cramp, fainting, heat stroke or skin disorders). Excessive heat also decreases the durability of the artificial surface. It would be desirable to improve the usability of artificial sports fields by decreasing the surface temperature.

Artificial sports fields typically contain an infill layer to provide the required play performance and to stabilise the artificial turf. Typically, the infill layer comprises a layer of sand (between 10 to 20 mm to stabilise the turf) and a plastics layer (5 to 50 mm to provide the sport performance). Plastics such as granulated styrene butadiene rubber (SBR), ethylene propylene diene monomer rubber (EPDM) or thermoplastic elastomers (TPE) are most preferred. Research has shown that microplastics from this plastic infill layer migrate into the surrounding environment causing marine pollution. Several countries are therefore adopting legislation to reduce or completely remove products producing microplastic pollution. It would therefore be desirable to produce a sports field that does not require the use of a plastic infill layer i.e. the required sports performance level can be met without the need for a plastics infill layer.

Furthermore, the binders of choice for man-made vitreous fibre products have been phenol-formaldehyde resins and phenol-formaldehyde urea resins. These binders are economical to produce and provide excellent mechanical handling properties. This is highly important as the shock pads are positioned underground and must be able to withstand the process of installation, and then pressure from above the ground during use (e.g. from players).

However, existing and proposed legislation directed to the lowering or elimination of formaldehyde emissions during manufacturing from the production facility, but also in the working environment, has led to the development of formaldehyde-free binders. There is also an on-going trend for consumers to prefer products that are fully or at least partially produced from renewable materials and there is therefore a need to provide binders for shock pads that are at least partially produced from renewable materials. Furthermore, known formaldehyde-based binders often involved corrosive and/or harmful components. This required protective measures for the machinery and safety measures for persons handling the machinery.

Formaldehyde-free binders for man-made vitreous fibre (MMVF) products have been proposed before. However, there are still some disadvantages associated with MMVF products prepared with these binders in terms of lower mechanical properties, when compared with MMVF products prepared with phenol-formaldehyde resins. In addition, such binders are often made from expensive starting materials.

In addition, it would be desirable to improve the water handling properties of shock pads, for example water absorption.

Furthermore, MMVF products may typically contain wetting agents to improve hydrophilicity. However, certain wetting agents may be washed out of the MMVF product over time. This is particularly problematic as shock pads are positioned in the ground and thus the wetting agent may leech out and contaminate the surrounding ground. In addition, as the wetting agent is washed out, the drainage properties of the shock pad would significantly change. Finally, there is an ongoing desire to reduce the number of components required to produce shock pads for both environmental and cost efficiency purposes.

There is a need for a shock pad for artificial playing fields that is improved in comparison to existing foam, rubber, plastic or polymeric shock pads. There is a need for a shock pad that is more durable and/or more resilient than existing foam, rubber, plastic or polymeric shock pads. There is a need for a shock pad that does so and meets the standards set out by international governing bodies of sports such as FIFA for football and FIH for hockey. There is a need for a shock pad that improves the usability of the artificial sports field by absorbing water (e.g. rainwater). There is a need for a shock pad that can actively prevent or treat flooding by absorbing water. There is a need for a shock pad that can prolong usability of the sports field by decreasing the surface temperature. There is a need for a shock pad that is environmentally acceptable and economical in terms of production, installation and use.

Furthermore, there is a need for a shock pad that can be installed in an artificial sports field without the need for plastic infill layers. There is a need for a shock pad with a binder that is formaldehyde-free but has equivalent or superior mechanical handling properties (e.g. wet strength and delamination strength) as phenol-formaldehyde binders. It would be desirable for such a binder to have improved water holding properties (e.g. water absorption). Furthermore, it would be desirable for such a binder to be economical to produce and be based predominantly on renewable sources. Finally, it would be desirable for such a binder not to require the further addition of wetting agent and thus prevent leeching of wetting agents into the surrounding ground.

### SUMMARY OF THE INVENTION

In a first aspect of the invention, there is provided a sports field comprising:
(i) a lower base layer;
(ii) an upper grass and/or artificial grass layer;
(iii) a shock pad layer, positioned between the base layer and the grass and/or artificial grass layer;
   wherein the shock pad layer comprises at least one shock pad comprising a coherent plate having upper and lower major surfaces, wherein the coherent plate comprises at least one coherent layer comprising man-made vitreous fibres (MMVF) bonded with a cured aqueous binder composition free of phenol and formaldehyde; wherein the aqueous binder composition prior to curing comprises:
a component (i) in form of one or more lignosulfonate lignins having a carboxylic acid group content of 0.03 to 1.4 mmol/g, based on the dry weight of the lignosulfonate lignins,
a component (ii) in form of one or more cross-linkers.

In a second aspect of the invention there is provided a method of producing a sports field, comprising the steps of:
(i) providing a lower base layer;
(ii) providing a shock pad layer above the base layer;
(iii) providing an upper grass and/or artificial grass layer above the shock pad layer;
   wherein the shock pad layer comprises at least one shock pad comprising a coherent plate having upper and lower major surfaces, wherein the coherent plate comprises at least one coherent layer comprising man-made vitreous fibres (MMVF) bonded with a cured aqueous binder composition free of phenol and formladehyde; wherein the aqueous binder composition prior to curing comprises:
a component (i) in form of one or more lignosulfonate lignins having a carboxylic acid group content of 0.03 to 1.4 mmol/g, based on the dry weight of the lignosulfonate lignins,
a component (ii) in form of one or more cross-linkers.

In a third aspect of the invention there is provided a shock pad comprising a coherent plate having upper and lower major surfaces, wherein the coherent plate comprises at least one coherent layer comprising man-made vitreous fibres (MMVF) bonded with a cured aqueous binder composition free of phenol and formaldehyde; wherein the aqueous binder composition prior to curing comprises:
a component (i) in form of one or more lignosulfonate lignins having a carboxylic acid group content of 0.03 to 1.4 mmol/g, based on the dry weight of the lignosulfonate lignins,
a component (ii) in form of one or more cross-linkers.

In a fourth aspect of the invention there is provided a method of producing a shock pad comprising the steps of:
(i) providing man-made vitreous fibres;
(ii) spraying the man-made vitreous fibres with an aqueous binder composition free of phenol and formaldehyde;
(iii) collecting and consolidating the man-made vitreous fibres and curing the aqueous binder composition to form a coherent layer;
(iv) providing a coherent plate having upper and lower major surfaces, wherein the coherent plate comprises at least one coherent layer;
   wherein the aqueous binder composition prior to curing comprises:
a component (i) in form of one or more lignosulfonate lignins having a carboxylic acid group content of 0.03 to 1.4 mmol/g, based on the dry weight of the lignosulfonate lignins,
a component (ii) in form of one or more cross-linkers.

In a fifth aspect of the invention there is provided a method of using a shock pad to provide a shock-absorbing surface in a sports field, comprising the step of: positioning a shock pad or an array of shock pads beneath the surface of a sports field, wherein the shock pad comprises: a coherent plate having upper and lower major surfaces, wherein the coherent plate comprises at least one coherent layer comprising man-made vitreous fibres (MMVF) bonded with a cured aqueous binder composition free of phenol and formladehyde; wherein the aqueous binder composition prior to curing comprises:
a component (i) in form of one or more lignosulfonate lignins having a carboxylic acid group content of 0.03 to 1.4 mmol/g, based on the dry weight of the lignosulfonate lignins,
a component (ii) in form of one or more cross-linkers.

In a sixth aspect of the invention there is provided use of a shock pad for absorbing shock in a sports field, wherein the shock pad comprises: a coherent plate having upper and lower major surfaces, wherein the coherent plate comprises at least one coherent layer comprising man-made vitreous fibres (MMVF) bonded with a cured aqueous binder composition free of phenol and formaldehyde; wherein the aqueous binder composition prior to curing comprises:
a component (i) in form of one or more lignosulfonate lignins having a carboxylic acid group content of 0.03 to 1.4 mmol/g, based on the dry weight of the lignosulfonate lignins,
a component (ii) in form of one or more cross-linkers.

In a seventh aspect of the invention there is provided use of a shock pad for absorbing and/or draining water in a sports field, wherein the shock pad comprises: a coherent plate having upper and lower major surfaces, wherein the coherent plate comprises at least one coherent layer comprising man-made vitreous fibres (MMVF) bonded with a cured aqueous binder composition free of phenol and formaldehyde; wherein the aqueous binder composition prior to curing comprises:
a component (i) in form of one or more lignosulfonate lignins having a carboxylic acid group content of 0.03 to 1.4 mmol/g, based on the dry weight of the lignosulfonate lignins,
a component (ii) in form of one or more cross-linkers.

In an eighth aspect of the invention there is provided Use of a shock pad for cooling the surface temperature of a sports field, wherein the shock pad comprises: a coherent plate having upper and lower major surfaces, wherein the coherent plate comprises at least one coherent layer comprising man-made vitreous fibres (MMVF) bonded with a cured aqueous binder composition free of phenol and formladehyde; wherein the aqueous binder composition prior to curing comprises:
a component (i) in form of one or more lignosulfonate lignins having a carboxylic acid group content of 0.03 to 1.4 mmol/g, based on the dry weight of the lignosulfonate lignins,
a component (ii) in form of one or more cross-linkers.

In a ninth aspect of the invention there is provided use of a lignin component in form of one or more lignosulfonate lignins having a carboxylic acid group content of 0.03 to 1.4 mmol/g, based on the dry weight of the lignosulfonate lignins, for the preparation of a binder composition free of phenol and formaldehyde for a coherent plate of a shock pad comprising man-made vitreous fibres (MMVF) bonded.

The inventors of the present invention discovered that the shock pad according to the present invention solves the above-described problems.

The shock pad according to the present invention is improved in comparison to existing foam, rubber, plastic or polymeric shock pads. It is more durable and/or more resilient than existing foam, rubber, plastic or polymeric shock pads and meets the standards set out by international governing bodies of sports such as FIFA for football and FIH for hockey. The shock pad according to the invention can actively prevent or treat flooding by absorbing water. The shock pad according to the invention can hold water in its structure and therefore improves the sports performance of the sports field—the inventors discovered that a plastic infill layer is thus no longer required due to water being absorbed and stored in the shock pad. The shock pad according to the invention also allows the stored water to evaporate thus cooling the surface temperature, by direct contact with temperature and wind through the upper layer or by absorption of water by the upper layer. The shock pad according to the invention is environmentally acceptable and economical in terms of production, installation and use.

Crucially, the inventors discovered a binder for a shock pad that is formaldehyde-free but has equivalent or superior mechanical handling properties (e.g. wet strength and delamination strength) as phenol-formaldehyde binders. The binder also has improved water holding properties (e.g. water absorption), is economical to produce and is based predominantly on renewable sources. Finally, the binder does not require the further addition of wetting agent and thus prevents leeching of wetting agents into the surrounding ground.

### BRIEF DESCRIPTION OF THE FIGURES

FIG. 1 shows a cross-sectional view of a shock pad according to a first embodiment of the invention.

FIG. 2 shows a cross-sectional view of a shock pad according to a second embodiment of the invention.

FIG. 3 shows a cross-sectional view of a shock pad according to the invention installed in the ground of an artificial sports field.

FIG. 4 shows commonly used model structure of lignosulfonates.

### DETAILED DESCRIPTION

The invention relates to a sports field comprising a shock pad, preferably artificial sports fields. The term shock pad has its normal meaning in the art. A shock pad is an underlay that is positioned underneath, often directly underneath, the surface of sports fields. Sports fields may also be called sports grounds, playing fields or playing grounds. Sports fields include football pitches, hockey pitches, rugby pitches, cricket pitches, padel courts, lawn bowling greens, lawn tennis courts, golf greens, athletic grounds and equestrian centres. The shock pad according to the present invention is particularly useful for football pitches and hockey pitches. This is because the shock pad according to the present invention meets the criteria set by football and hockey governing bodies, such as FIFA and FIH.

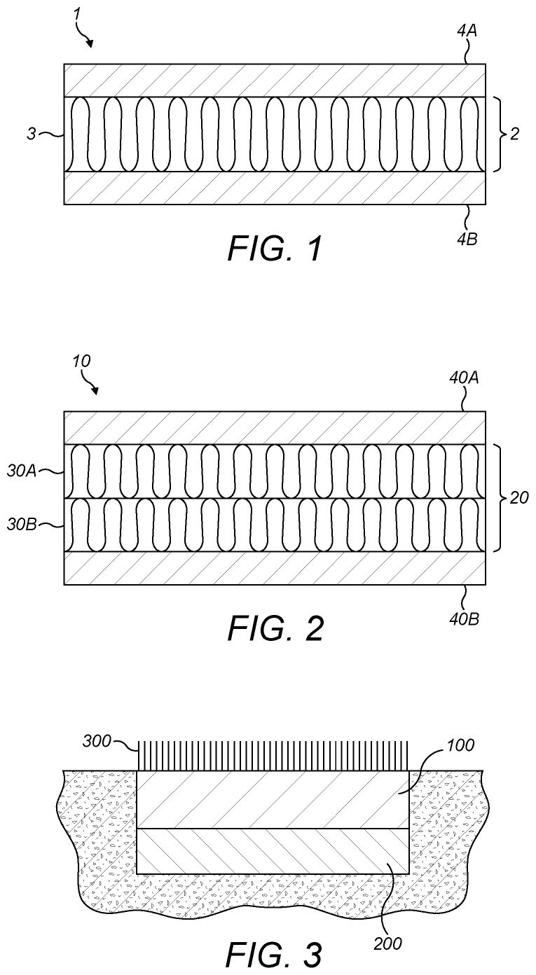

FIG. 1 shows a first embodiment of the invention. The shock pad (1) according to the present invention comprises a coherent plate (2) having upper and lower major surfaces wherein the coherent plate comprises at least one coherent layer (3) comprising man-made vitreous fibres (MMVF) bonded with a cured binder composition. The shock pad may further comprise an upper membrane layer (4a) bonded to the upper major surface of the coherent plate (2) and optionally a lower membrane layer (4b) bonded to the lower major surface of the coherent plate (2).

The upper and lower major surfaces of the coherent plate are preferably generally flat or flat i.e., are level. The coherent plate is preferably cubic or cuboidal in shape.

The shock pad can have any dimension suitable for use. For example, it may have a length of 0.5 m to 10 m, preferably 1 m to 2 m, most preferably 1.2 m. It may have a width of 0.2 m to 10 m, preferably 0.75 m to 1.5 m, most preferably 1 m.

The coherent plate comprises at least one coherent layer. The coherent layer comprises man-made vitreous fibres (MMVF) bonded with a cured binder composition.

The man-made vitreous fibres (MMVF) can have any suitable oxide composition. The fibres can be glass fibres, ceramic fibres, basalt fibres, slag fibres or rock or stone fibres.

The fibres are preferably of the types generally known as rock, stone or slag fibres, most preferably stone fibres.

Stone fibres commonly comprise the following oxides, in percent by weight:
SiO₂: 30 to 51
Al₂O₃:12 to 30
CaO: 8 to 30
MgO: 2 to 25
FeO (including Fe₂O₃): 2 to 15
Na₂O+K₂O: not more than 10
CaO+MgO: 10 to 30.

In preferred embodiments the MMVF have the following levels of elements, calculated as oxides in wt %:
SiO₂: at least 30, 32, 35 or 37; not more than 51, 48, 45 or 43
Al₂O₃: at least 12, 16 or 17; not more than 30, 27 or 25
CaO: at least 8 or 10; not more than 30, 25 or 20
MgO: at least 2 or 5; not more than 25, 20 or 15
FeO (including Fe₂O₃): at least 4 or 5; not more than 15, 12 or 10
FeO+MgO: at least 10, 12 or 15; not more than 30, 25 or 20.
Na₂O+K₂O: zero or at least 1; not more than 10
CaO+MgO: at least 10 or 15; not more than 30 or 25
TiO₂: zero or at least 1; not more than 6, 4 or 2
TiO₂+FeO: at least 4 or 6; not more than 18 or 12
B₂O₃: zero or at least 1; not more than 5 or 3
P₂O₅: zero or at least 1; not more than 8 or 5
Others: zero or at least 1; not more than 8 or 5.

The MMVF made by the method of the invention preferably have the composition in wt %:

| | |
|---|---|
| SiO₂ | 35 to 50 |
| Al₂O₃ | 12 to 30 |
| TiO₂ | up to 2 |
| Fe₂O₃ | 3 to 12 |
| CaO | 5 to 30 |
| MgO | up to 15 |
| Na₂O | 0 to 15 |
| K2O | 0 to 15 |
| P₂O₅ | up to 3 |
| MnO | up to 3 |
| B₂O₃ | up to 3. |

Another preferred composition for the MMVF is as follows in wt %:
SiO₂ 39-55% preferably 39-52%
Al₂O₃ 16-27% preferably 16-26%
CaO 6-20% preferably 8-18%
MgO 1-5% preferably 1-4.9%
Na₂O 0-15% preferably 2-12%
K₂O 0-15% preferably 2-12%
R₂O (Na₂O+K₂O) 10-14.7% preferably 10-13.5%
P₂O₅ 0-3% preferably 0-2%
Fe₂O₃ (iron total) 3-15% preferably 3.2-8%
B₂O₃ 0-2% preferably 0-1%
TiO₂ 0-2% preferably 0.4-1%
Others 0-2.0%.

Glass fibres commonly comprise the following oxides, in percent by weight:
SiO₂: 50 to 70
Al₂O₃: 10 to 30
CaO: not more than 27
MgO: not more than 12.

Glass fibres can also contain the following oxides, in percent by weight:
Na₂O+K₂O: 8 to 18, in particular Na₂O+K₂O greater than CaO+MgO
B₂O₃: 3 to 12.

Some glass fibre compositions can contain Al₂O₃: less than 2%.

The geometric mean fibre diameter is preferably in the range of 1.5 to 10 microns, in particular 2 to 8 microns, more preferably 2 to 5 microns. The inventors found that this range of geometric fibre diameter positively affects capillarity thus improving water uptake in the shock pad.

The coherent layer is preferably in the form of a coherent mass of MMVF i.e. a MMVF substrate. That is, the coherent layer is generally a coherent matrix of MMVF fibres bonded with a cured binder composition, which has been produced as such, or has been formed by granulating a slab of MMVF and consolidating the granulated material. A coherent substrate is a single, unified substrate.

The present shock pad containing MMVF has the advantage of being more environmentally friendly than shock pads made from plastic, foam, rubber or polymeric material.

The at least one coherent layer may have a thickness in the range of 12 mm to 60 mm, preferably 15 mm to 40 mm, more preferably 20 mm to 35 mm, most preferably 23 mm to 30 mm. By thickness it is meant the dimension from the upper surface of the coherent layer to the lower surface i.e. the height of the coherent layer when the shock pad is in use. The advantage of having a shock pad with a coherent layer of thickness 12 mm to 60 mm is that it achieves the desired water management properties (i.e. absorbing, storing and draining excess water; cooling the surface of artificial sports fields) but also meets the strict requirements set by international governing bodies of sports for artificial playing fields. In addition, this size conforms to standard construction requirements that makes installation of the shock pad more convenient.

The at least one coherent layer may have a density in the range of 175 kg/m³ to 300 kg/m³, preferably in the range of 220 kg/m³ to 280 kg/m³, most preferably 275 kg/m³. The advantage of having a shock pad with coherent layer of density in the range of 175 kg/m³ to 300 kg/m³ is that it achieves the optimum balance between durability and sports performance. The shock pad according to the present invention meets the sports performance requirements set by governing bodies, but is also highly durable.

The shock pad according to the invention comprises a coherent layer comprising an aqueous binder composition free of phenol and formaldehyde that, prior to curing, comprises:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers.

In one embodiment, the aqueous binder composition comprises:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers,
   with the proviso that the aqueous binder composition does not comprise a cross-linker selected from epoxy compounds having a molecular weight M_{w} of 500 or less.

In one embodiment, the aqueous binder composition comprises:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers,
   with the proviso that the aqueous binder composition does not comprise a cross-linker selected from:
carbonyl compounds selected from aldehydes, carbonyl compounds of the formula R—[C(O)R₁]ₓ
   in which:
R represents a saturated or unsaturated and linear, branched or cyclic hydrocarbon radical, a radical including one or more aromatic nuclei which consist of 5 or 6 carbon atoms, a radical including one or more aromatic heterocycles containing 4 or 5 carbon atoms and an oxygen, nitrogen or sulfur atom, it being possible for the R radical to contain other functional groups, R₁ represents a hydrogen atom or a C₁-C₁₀ alkyl radical, and x varies from 1 to 10.

In one embodiment, the aqueous binder composition comprises:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers, with the proviso that the aqueous binder composition does not comprise a cross-linker selected from polyamines.

In one embodiment, the aqueous binder composition comprises:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers, with the proviso that the aqueous binder composition does not comprise a cross-linker selected from mono- and oligosaccharides.

In one embodiment, the aqueous binder composition comprises:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers selected from:
   β-hydroxyalkylamide-cross-linkers, such as N-(2-hydroxyisopropyl)amide-cross-linkers, such as N-(2-hydroxyethyl)amide-cross-linkers, such as N-(2-hydroxyethyl)adipamide-cross-linkers, such as N,N,N′,N′-tetrakis(2-hydroxyethyl)adipamide and/or
   the group consisting of multifunctional organic amines such as an alkanolamine, diamines, such as hexamethyldiamine, and/or
   epoxy compounds having a molecular weight of more than 500, such as an epoxidised oil based on fatty acid triglyceride or one or more flexible oligomer or polymer, such as a low Tg acrylic based polymer, such as a low Tg vinyl based polymer, such as low Tg polyether, which contains reactive functional groups such as carbodiimide groups, such as anhydride groups, such as oxazoline groups, such as amino groups, such as epoxy groups, and/or
   one or more cross-linkers in form of multifunctional carbodiimides, such as aliphatic multifunctional carbodiimides, and/or
   Primid XL-552,
      with the proviso that the aqueous binder composition does not comprise a cross-linker selected from:
epoxy compounds having a molecular weight M_{w} of 500 or less
carbonyl compounds selected from aldehydes, carbonyl compounds of the formula R—[C(O)R₁]ₓ
   in which:
R represents a saturated or unsaturated and linear, branched or cyclic hydrocarbon radical, a radical including one or more aromatic nuclei which consist of 5 or 6 carbon atoms, a radical including one or more aromatic heterocycles containing 4 or 5 carbon atoms and an oxygen, nitrogen or sulfur atom, it being possible for the R radical to contain other functional groups, R₁ represents a hydrogen atom or a C₁-C₁₀ alkyl radical, and x varies from 1 to 10,
polyamines.

Optionally, the aqueous binder composition additionally comprises:
a component (iii) in form of one or more plasticizers.

In one embodiment, the aqueous binder composition comprises:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers;
a component (iii) in form of one or more plasticizers.

In one embodiment, the aqueous binder composition comprises:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers;
a component (iii) in form of one or more plasticizers,
   with the proviso that the aqueous binder composition does not comprise a cross-linker selected from epoxy compounds having a molecular weight M_{w} of 500 or less.

In one embodiment, the aqueous binder composition comprises:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers;
a component (iii) in form of one or more plasticizers,
   with the proviso that the aqueous binder composition does not comprise a cross-linker selected from:
carbonyl compounds selected from aldehydes, carbonyl compounds of the formula R—[C(O)R₁]ₓ
   in which:
R represents a saturated or unsaturated and linear, branched or cyclic hydrocarbon radical, a radical including one or more aromatic nuclei which consist of 5 or 6 carbon atoms, a radical including one or more aromatic heterocycles containing 4 or 5 carbon atoms and an oxygen, nitrogen or sulfur atom, it being possible for the R radical to contain other functional groups, R₁ represents a hydrogen atom or a C₁-C₁₀ alkyl radical, and x varies from 1 to 10.

In one embodiment, the aqueous binder composition comprises:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers;
a component (iii) in form of one or more plasticizers,
   with the proviso that the aqueous binder composition does not comprise a cross-linker selected from polyamines.

In one embodiment, the aqueous binder composition comprises:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers;
a component (iii) in form of one or more plasticizers,
   with the proviso that the aqueous binder composition does not comprise a cross-linker selected from mono- and oligosaccharides.

In one embodiment, the aqueous binder composition comprises:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers selected from
   β-hydroxyalkylamide-cross-linkers, and/or
   epoxy compounds having a molecular weight of more than 500, such as an epoxidised oil based on fatty acid triglyceride or one or more flexible oligomer or polymer, such as a low Tg acrylic based polymer, such as a low Tg vinyl based polymer, such as low Tg polyether, which contains reactive functional groups such as carbodiimide groups, such as anhydride groups, such as oxazoline groups, such as amino groups, such as epoxy groups, and/or
   one or more cross-linkers in form of multifunctional carbodiimides, such as aliphatic multifunctional carbodiimides; and/or
   Primid XL-552;
a component (iii) in form of one or more plasticizers,
   with the proviso that the aqueous binder composition does not comprise a cross-linker selected from
epoxy compounds having a molecular weight M_{w} of 500 or less
carbonyl compounds selected from aldehydes, carbonyl compounds of the formula R—[C(O)R₁]ₓ
   in which:
R represents a saturated or unsaturated and linear, branched or cyclic hydrocarbon radical, a radical including one or more aromatic nuclei which consist of 5 or 6 carbon atoms, a radical including one or more aromatic heterocycles containing 4 or 5 carbon atoms and an oxygen, nitrogen or sulfur atom, it being possible for the R radical to contain other functional groups, R₁ represents a hydrogen atom or a C₁-C₁₀ alkyl radical, and x varies from 1 to 10,
   polyamines.

In a preferred embodiment, the binders are formaldehyde free.

For the purpose of the present application, the term “formaldehyde free” is defined to characterize a mineral wool product where the emission is below 5 μg/m²/h of formaldehyde from the mineral wool product, preferably below 3 μg/m²/h. Preferably, the test is carried out in accordance with ISO 16000 for testing aldehyde emissions.

In a preferred embodiment, the binders are phenol free.

For the purpose of the present application, the term “phenol free” is defined in such a way that the aqueous binder composition does contain phenol

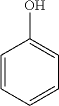

in an amount of s 0.25 wt.-%, such as <0.1 wt.-%, such as <0.05 wt.-%, based on the total weight of an aqueous composition having a dry solids binder content of 15 wt. %.

In one embodiment, the binder composition does not contain added formaldehyde.

In one embodiment, the binder composition does not contain added phenol.

For the purpose of the present invention, the term “mono- and oligosaccharides” is defined to comprise monosaccharides and oligosaccharides having 10 or less saccharide units.

For the purpose of the present invention, the term “sugar” is defined to comprise monosaccharides and oligosaccharides having 10 or less saccharide units.

### Component (i)

Component (i) is in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins.

Lignin, cellulose and hemicellulose are the three main organic compounds in a plant cell wall. Lignin can be thought of as the glue, that holds the cellulose fibres together. Lignin contains both hydrophilic and hydrophobic groups. It is the second most abundant natural polymer in the world, second only to cellulose, and is estimated to represent as much as 20-30% of the total carbon contained in the biomass, which is more than 1 billion tons globally.

The lignosulfonate process introduces large amount of sulfonate groups making the lignin soluble in water but also in acidic water solutions. Lignosulfonates has up to 8% sulfur as sulfonate, whereas kraft lignin has 1-2% sulfur, mostly bonded to the lignin. The molecular weight of lignosulfonate is 15.000-50.000 g/mol. The typical hydrophobic core of lignin together with large number of ionized sulfonate groups make this lignin attractive as a surfactant and it often finds application in dispersing cement etc.

To produce lignin-based value-added products, lignin should be first separated from biomass, for which several methods can be employed. Kraft and sulfite pulping processes are known for their effective lignin separation from wood, and hence, are used worldwide. Kraft lignin is separated from wood with the help of NaOH and Na2S. Lignins from sulfite pulping processes are denoted as lignosulfonates, and are produced by using sulfurous acid and/or a sulfite salt containing magnesium, calcium, sodium, or ammonium at varying pH levels. Currently, lignosulfonates account for 90% of the total market of commercial lignin, and the total annual worldwide production of lignosulfonates is approximately 1.8 million tons. Lignosulfonates have generally abundance of sulfonic groups, and thus, a higher amount of sulfur than kraft lignin. Due to the presence of the sulfonated group, lignosulfonates are anionically charged and water soluble. The molecular weights (Mw) of lignosulfonates can be similar to or larger than that of kraft lignin. Due to their unique properties, lignosulfonates have a wide range of uses, such as animal feed, pesticides, surfactants, additives in oil drilling, stabilizers in colloidal suspensions, and as plasticizers in concrete admixtures. However, the majority of new pulp mills employ kraft technology for pulp production, and thus, kraft lignin is more readily available for value-added production.

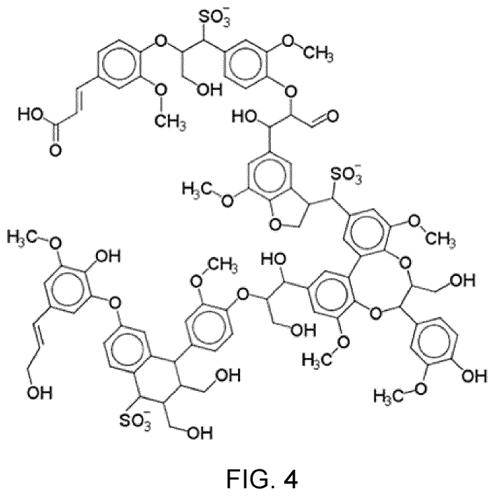

However, lignosulfonates and kraft lignin have different properties coming from different isolation processes and thus distribution of functional groups. High level of sulfonic groups in lignosulfonates, generally at least one for every four C9 units, makes lignosulfonates strongly charged at all pH levels in water. This abundance of ionisable functional groups can explain most of the differences compared to other technical lignins. Higher charge density allows easier water solubility and higher solid content in solution possible compared to kraft lignin. Also, for the same reason, lignosulfonates will have lower solution viscosity compared to kraft lignin at the same solid content which can facilitate handling and processing. Commonly used model structure of lignosulfonates is shown on FIG. 4.

In one embodiment, component (i) is having a carboxylic acid group content of 0.05 to 0.6 mmol/g, such as 0.1 to 0.4 mmol/g, based on the dry weight of lignosulfonate lignins.

In one embodiment, component (i) is in form of one or more lignosulfonate lignins having an average carboxylic acid group content of less than 1.8 groups per macromolecule considering the M_n wt. average of component (i), such as less than 1.4 such as less than 1.1 such as less than 0.7 such as less than 0.4.

In one embodiment, component (i) is having a content of phenolic OH groups of 0.3 to 2.5 mmol/g, such as 0.5 to 2.0 mmol/g, such as 0.5 to 1.5 mmol/g. based on the dry weight of lignosulfonate lignins.

In one embodiment, component (i) is having a content of aliphatic OH groups of 1.0 to 8.0 mmol/g, such as 1.5 to 6.0 mmol/g, such as 2.0 to 5.0 mmol/g, based on the dry weight of lignosulfonate lignins.

In one embodiment, component (i) comprises ammoniumlignosulfonates and/or calciumlignosulfonates, and/or magnesiumlignosulfonates, and any combinations thereof.

In one embodiment, component (i) comprises ammoniumlignosulfonates and calciumlignosulfonates, wherein the molar ratio of NH4+ to Ca2+ is in the range of 5:1 to 1:5, in particular 3:1 to 1:3.

For the purpose of the present invention, the term lignosulfonates encompasses sulfonated kraft lignins.

In one embodiment, component (i) is a sulfonated kraft lignin.

In one embodiment, the aqueous binder composition contains added sugar in an amount of 0 to 5 wt.-%, such as less than 5 wt.-%, such as 0 to 4.9 wt.-%, such as 0.1 to 4.9 wt.-%, based on the weight of lignosulfonate and sugar.

In one embodiment, the aqueous binder composition comprises component (i), i.e. the lignosulfonate, in an amount of 50 to 98 wt.-%, such as 65 to 98 wt.-%, such as 80 to 98 wt.-%, based on the total weight of components (i) and (ii).

In one embodiment, the aqueous binder composition comprises component (i) in an amount of 50 to 98 wt.-%, such as 65 to 98 wt.-%, such as 80 to 98 wt.-%, based on the dry weight of components (i), (ii), and (iii).

For the purpose of the present invention, content of lignin functional groups is determined by using 31P NMR as characterization method.

Sample preparation for 31P NMR is performed by using 2-chloro-4,4,5,5-tetramethyl-1,3,2-dioxaphospholane (TMDP) as phosphitylation reagent and cholesterol as internal standard. Integration is according to the work of Granata and Argyropoulos (J. Agric. Food Chem. 43:1538-1544).

### Component (ii)

Component (ii) is in form of one or more cross-linkers.

In one embodiment, the component (ii) comprises in one embodiment one or more cross-linkers selected from β-hydroxyalkylamide-cross-linkers and/or oxazoline-cross-linkers.

β-hydroxyalkylamide-cross-linkers is a curing agent for the acid-functional macromolecules. It provides a hard, durable, corrosion resistant and solvent resistant cross-linked polymer network. It is believed the β-hydroxyalkylamide cross-linkers cure through esterification reaction to form multiple ester linkages. The hydroxy functionality of the β-hydroxyalkylamide-cross-linkers should be an average of at least 2, preferably greater than 2 and more preferably 2-4 in order to obtain optimum curing response.

Oxazoline group containing cross-linkers are polymers containing one of more oxazoline groups in each molecule and generally, oxazoline containing cross-linkers can easily be obtained by polymerizing an oxazoline derivative. The U.S. Pat. No. 6,818,699 B2 provides a disclosure for such a process.

In one embodiment, the component (ii) is one or more epoxy compounds having a molecular weight of more than 500, such as an epoxidised oil based on fatty acid triglyceride or one or more flexible oligomer or polymer, such as a low Tg acrylic based polymer, such as a low Tg vinyl based polymer, such as low Tg polyether, which contains reactive functional groups such as carbodiimide groups, such as anhydride groups, such as oxazoline groups, such as amino groups, such as epoxy groups, such as β-hydroxyalkylamide groups.

In one embodiment, component (ii) is one or more cross-linkers selected from the group consisting of fatty amines.

In one embodiment, component (ii) is one or more cross-linkers in form of fatty amides.

In one embodiment, component (ii) is one or more cross-linkers selected from polyester polyols, such as polycaprolactone.

In one embodiment, component (ii) is one or more cross-linkers selected from the group consisting of starch, modified starch, CMC.

In one embodiment, component (ii) is one or more cross-linkers in form of multifunctional carbodiimides, such as aliphatic multifunctional carbodiimides.

In one embodiment, the component (ii) is one or more cross-linkers in form of aziridines, such as CX100, NeoAdd-Pax 521/523.

In one embodiment, component (ii) is one or more cross-linkers selected from melamine based cross-linkers, such as a hexakis(methylmethoxy)melamine (HMMM) based cross-linkers.

Examples of such compounds are Picassian XL 701, 702, 725 (Stahl Polymers), such as ZOLDINEO XL-29SE (Angus Chemical Company), such as CX300 (DSM), such as Carbodilite V-02-L2 (Nisshinbo Chemical Inc.).

In one embodiment, component (ii) is Primid XL552, which has the following structure:

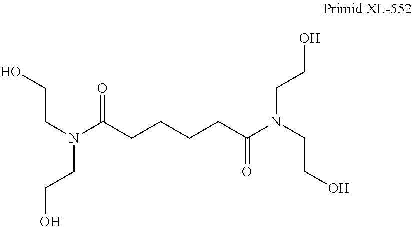 [SMILES: O=C(CCCCC(=O)N(CCO)CCO)N(CCO)CCO]

Component (ii) can also be any mixture of the above mentioned compounds.

In one embodiment, the binder composition according to the present invention comprises component (ii) in an amount of 1 to 50 wt.-%, such as 4 to 20 wt.-%, such as 6 to 12 wt.-%, based on the dry weight of component (i).

In one embodiment, component (ii) is in form of one or more cross-linkers selected from;
β-hydroxyalkylamide-cross-linkers, such as N-(2-hydroxyisopropyl)amide-cross-linkers, such as N-(2-hydroxyethyl)amide-cross-linkers, such as N-(2-hydroxyethyl)adipamide-cross-linkers, such as N,N,N′,N′-tetrakis(2-hydroxyethyl)adipamide and/or
the group consisting of multifunctional organic amines such as an alkanolamine, diamines, such as hexamethyldiamine, and/or
epoxy compounds having a molecular weight of more than 500, such as an epoxidised oil based on fatty acid triglyceride or one or more flexible oligomer or polymer, such as a low Tg acrylic based polymer, such as a low Tg vinyl based polymer, such as low Tg polyether, which contains reactive functional groups such as carbodiimide groups, such as anhydride groups, such as oxazoline groups, such as amino groups, such as epoxy groups, and/or
one or more cross-linkers in form of multifunctional carbodiimides, such as aliphatic multifunctional carbodiimides.

In one embodiment, component (ii) comprises one or more cross-linkers selected from
β-hydroxyalkylamide-cross-linkers, such as N-(2-hydroxyisopropyl)amide-cross-linkers, such as N-(2-hydroxyethyl)amide-cross-linkers, such as N-(2-hydroxyethyl)adipamide-cross-linkers, such as N,N,N′,N′-tetrakis(2-hydroxyethyl)adipamide.

In one embodiment, component (ii) comprises component (ii) in an amount of 2 to 90 wt.-%, such as 6 to 60 wt.-%, such as 10 to 40 wt.-%, such as 25 to 40 wt.-%, based on the dry weight of component (i).

Component (iii)

Optionally, the binder composition may comprise a component (iii). Component (iii) is in form of one or more plasticizers.

In one embodiment, component (iii) is in form of one or more plasticizers selected from the group consisting of polyols, such as carbohydrates, hydrogenated sugars, such as sorbitol, erythriol, glycerol, monoethylene glycol, polyethylene glycols, polyethylene glycol ethers, polyethers, phthalates and/or acids, such as adipic acid, vanillic acid, lactic acid and/or ferullic acid, acrylic polymers, polyvinyl alcohol, polyurethane dispersions, ethylene carbonate, propylene carbonate, lactones, lactams, lactides, acrylic based polymers with free carboxy groups and/or polyurethane dispersions with free carboxy groups, polyamides, amides such as carbamide/urea, or any mixtures thereof.

In one embodiment, component (iii) is in form of one or more plasticizers selected from the group consisting of carbonates, such as ethylene carbonate, propylene carbonate, lactones, lactams, lactides, compounds with a structure similar to lignin like vanillin, acetosyringone, solvents used as coalescing agents like alcohol ethers, polyvinyl alcohol.

In one embodiment, component (iii) is in form of one or more non-reactive plasticizer selected from the group consisting of polyethylene glycols, polyethylene glycol ethers, polyethers, hydrogenated sugars, phthalates and/or other esters, solvents used as coalescing agents like alcohol ethers, acrylic polymers, polyvinyl alcohol.

In one embodiment, component (iii) is one or more reactive plasticizers selected from the group consisting of carbonates, such as ethylene carbonate, propylene carbonate, lactones, lactams, lactides, di- or tricarboxylic acids, such as adipic acid, or lactic acid, and/or vanillic acid and/or ferullic acid, polyurethane dispersions, acrylic based polymers with free carboxy groups, compounds with a structure similar to lignin like vanillin, acetosyringone.

In one embodiment, component (iii) is in form of one or more plasticizers selected from the group consisting of fatty alcohols, monohydroxy alcohols such as pentanol, stearyl alcohol.

In one embodiment, component (iii) comprises one or more plasticizers selected from the group consisting of polyethylene glycols, polyethylene glycol ethers, and/or one or more plasticizers in form of polyols, such as 1,1,1-Tris(hydroxymethyl)propane, and/or triethanolamine.

Another particular surprising aspect of the present invention is that the use of plasticizers having a boiling point of more than 100° C., in particular 140 to 250° C., strongly improves the mechanical properties of the mineral fibre products according to the present invention although, in view of their boiling point, it is likely that these plasticizers will at least in part evaporate during the curing of the binders in contact with the mineral fibres.

In one embodiment, component (iii) comprises one or more plasticizers having a boiling point of more than 100° C., such as 110 to 380° C., more preferred 120 to 300° C., more preferred 140 to 250° C.

It is believed that the effectiveness of these plasticizers in the binder composition according to the present invention is associated with the effect of increasing the mobility of the lignins during the curing process. It is believed that the increased mobility of the lignins during the curing process facilitates the effective cross-linking.

In one embodiment, component (iii) comprises one or more polyethylene glycols having an average molecular weight of 150 to 50000 g/mol, in particular 150 to 4000 g/mol, more particular 150 to 1000 g/mol, preferably 150 to 500 g/mol, more preferably 200 to 400 g/mol.

In one embodiment, component (iii) comprises one or more polyethylene glycols having an average molecular weight of 4000 to 25000 g/mol, in particular 4000 to 15000 g/mol, more particular 8000 to 12000 g/mol.

In one embodiment component (iii) is capable of forming covalent bonds with component (i) and/or component (ii) during the curing process. Such a component would not evaporate and remain as part of the composition but will be effectively altered to not introduce unwanted side effects e.g. water absorption in the cured product. Non-limiting examples of such a component are caprolactone and acrylic based polymers with free carboxyl groups.

In one embodiment, component (iii) is selected from the group consisting of fatty alcohols, monohydroxy alcohols, such as pentanol, stearyl alcohol.

In one embodiment, component (iii) is selected from one or more plasticizers selected from the group consisting of alkoxylates such as ethoxylates such as butanol ethoxylates, such as butoxytriglycol.

In one embodiment, component (iii) is selected from one or more propylene glycols.

In one embodiment, component (iii) is selected from one or more glycol esters.

In one embodiment, component (iii) is selected from one or more plasticizers selected from the group consisting of adipates, acetates, benzoates, cyclobenzoates, citrates, stearates, sorbates, sebacates, azelates, butyrates, valerates.

In one embodiment, component (iii) is selected from one or more plasticizers selected from the group consisting of phenol derivatives such as alkyl or aryl substituted phenols.

In one embodiment, component (iii) is selected from one or more plasticizers selected from the group consisting of silanols, siloxanes.

In one embodiment, component (iii) is selected from one or more plasticizers selected from the group consisting of sulfates such as alkyl sulfates, sulfonates such as alkyl aryl sulfonates such as alkyl sulfonates, phosphates such as tripolyphosphates; such as tributylphosphates.

In one embodiment, component (iii) is selected from one or more hydroxy acids.

In one embodiment, component (iii) is selected from one or more plasticizers selected from the group consisting of monomeric amides such as acetamides, benzamide, fatty acid amides such as tall oil amides.

In one embodiment, component (iii) is selected from one or more plasticizers selected from the group consisting of quaternary ammonium compounds such as trimethylglycine, distearyldimethylammoniumchloride.

In one embodiment, component (iii) is selected from one or more plasticizers selected from the group consisting of vegetable oils such as castor oil, palm oil, linseed oil, tall oil, soybean oil.

In one embodiment, component (iii) is in form of tall oil.

In one embodiment, component (iii) is selected from one or more plasticizers selected from the group consisting of hydrogenated oils, acetylated oils.

In one embodiment, component (iii) is selected from one or more fatty acid methyl esters.

In one embodiment, component (iii) is selected from one or more plasticizers selected from the group consisting of alkyl polyglucosides, gluconamides, aminoglucoseamides, sucrose esters, sorbitan esters.

In one embodiment, component (iii) is selected from the group consisting of polyethylene glycols, polyethylene glycol ethers.

In one embodiment, component (iii) is selected from the group consisting of triethanolamine.

In one embodiment, component (iii) is in form of propylene glycols, phenol derivatives, silanols, siloxanes, hydroxy acids, vegetable oils, polyethylene glycols, polyethylene glycol ethers, and/or one or more plasticizers in form of polyols, such as 1,1,1-Tris(hydroxymethyl)propane, triethanolamine, or any mixtures thereof.

It has surprisingly been found that the inclusion of plasticizers in the binder compositions according to the present invention strongly improves the mechanical properties of the mineral fibre products according to the present invention.

The term plasticizer refers to a substance that is added to a material in order to make the material softer, more flexible (by decreasing the glass-transition temperature Tg) and easier to process.

Component (iii) can also be any mixture of the above mentioned compounds.

In one embodiment, component (iii) is present in an amount of 0.5 to 60, preferably 2.5 to 25, more preferably 3 to 15 wt.-%, based on the dry weight of component (i).

In one embodiment, component (iii) is present in an amount of 0.5 to 60, preferably 2.5 to 25, more preferably 3 to 15 wt.-%, based on the dry weight of components (i), (ii), and (iii).

### Binder Composition Comprising Components (i) and (Iia)

In one embodiment, the present invention is directed to a sports field comprising:
(i) a lower base layer;
(ii) an upper grass and/or artificial grass layer;
(iii) a shock pad layer, positioned between the base layer and the grass and/or artificial grass layer;
   wherein the shock pad layer comprises at least one shock pad comprising a coherent plate having upper and lower major surfaces, wherein the coherent plate comprises at least one coherent layer comprising man-made vitreous fibres (MMVF) bonded with a cured aqueous binder composition free of phenol and formaldehyde; wherein the aqueous binder composition prior to curing comprises:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins.
a component (iia) in form of one or more modifiers,
   preferably with the proviso that the aqueous binder composition does not comprise a cross-linker selected from:
a epoxy compounds having a molecular weight M_{w} of 500 or less,
   and/or with the proviso that the aqueous binder composition does not comprise a cross-linker selected from
carbonyl compounds selected from aldehydes, carbonyl compounds of the formula R—[C(O)R₁]ₓ
   in which:
R represents a saturated or unsaturated and linear, branched or cyclic hydrocarbon radical, a radical including one or more aromatic nuclei which consist of 5 or 6 carbon atoms, a radical including one or more aromatic heterocycles containing 4 or 5 carbon atoms and an oxygen, nitrogen or sulfur atom, it being possible for the R radical to contain other functional groups, R₁ represents a hydrogen atom or a C₁-C₁₀ alkyl radical, and x varies from 1 to 10,
   and/or with the proviso that the aqueous binder composition does not comprise a cross-linker selected from
polyamines,
   and/or with the proviso that the aqueous binder composition does not comprise a cross-linker selected from
mono- and oligosaccharides.

The present inventors have found that the excellent binder properties can also be achieved by a two-component system which comprises component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins and a component (iia) in form of one or more modifiers, and optionally any of the other components mentioned above and below.

In one embodiment, component (iia) is a modifier in form of one or more compounds selected from the group consisting of epoxy compounds having a molecular weight of more than 500, such as an epoxidised oil based on fatty acid triglyceride or one or more flexible oligomer or polymer, such as a low Tg acrylic based polymer, such as a low Tg vinyl based polymer, such as low Tg polyether, which contains reactive functional groups such as carbodiimide groups, such as anhydride groups, such as oxazoline groups, such as amino groups, such as epoxy groups such as β-hydroxyalkylamide groups.

In one embodiment, component (iia) is one or more modifiers selected from the group consisting of polyethylene imine, polyvinyl amine, fatty amines.

In one embodiment, the component (iia) is one or more modifiers selected from multifunctional carbodiimides, such as aliphatic multifunctional carbodiimides.

Component (iia) can also be any mixture of the above mentioned compounds.

Without wanting to be bound by any particular theory, the present inventors believe that the excellent binder properties achieved by the binder composition for MMVF comprising components (i) and (iia), and optional further components, are at least partly due to the effect that the modifiers used as components (iia) at least partly serve the function of a plasticizer and a cross-linker.

In one embodiment, the binder composition comprises component (iia) in an amount of 1 to 40 wt.-%, such as 4 to 20 wt.-%, such as 6 to 12 wt.-%, based on the dry weight of the component (i).

### Further Components

In some embodiments, the binder composition comprises further components.

In one embodiment, the binder composition comprises a catalyst selected from inorganic acids, such as sulfuric acid, sulfamic acid, nitric acid, boric acid, hypophosphorous acid, and/or phosphoric acid, and/or any salts thereof such as sodium hypophosphite, and/or ammonium salts, such as ammonium salts of sulfuric acid, sulfamic acid, nitric acid, boric acid, hypophosphorous acid, and/or phosphoric acid, and/or sodium polyphosphate (STTP), and/or sodium metaphosphate (STMP), and/or phosphorous oxychloride. The presence of such a catalyst can improve the curing properties of the binder compositions according to the present invention.

In one embodiment, the binder composition comprises a catalyst selected from Lewis acids, which can accept an electron pair from a donor compound forming a Lewis adduct, such as ZnCl₂, Mg (ClO₄)₂, Sn [N(SO₂-n-C₈F₁₇)₂]₄.

In one embodiment, the binder composition comprises a catalyst selected from metal chlorides, such as KCl, MgCl₂, ZnCl₂, FeCl₃ and SnCl₂ or their adducts such as AlCl₃ adducts, such as BF₃ adducts, such as BF₃ ethylamine complex.

In one embodiment, the binder composition comprises a catalyst selected from organometallic compounds, such as titanate-based catalysts and stannum based catalysts.

In one embodiment, the binder composition comprises a catalyst selected from chelating agents, such as transition metals, such as iron ions, chromium ions, manganese ions, copper ions and/or from peroxides such as organic peroxides such as dicumyl peroxide.

In one embodiment, the binder composition according to the present invention comprises a catalyst selected from phosphites such as alkyl phosphites, such as aryl phosphites such as triphenyl phosphite.

In one embodiment, the binder composition according to the present invention comprises a catalyst selected from the group of ternary amines such as tris-2,4,6-dimethylaminomethyl phenol.

In one embodiment, the binder composition further comprises a further component (iv) in form of one or more silanes.

In one embodiment, the binder composition comprises a further component (iv) in form of one or more coupling agents, such as organofunctional silanes.

In one embodiment, component (iv) is selected from group consisting of organofunctional silanes, such as primary or secondary amino functionalized silanes, epoxy functionalized silanes, such as polymeric or oligomeric epoxy functionalized silanes, methacrylate functionalized silanes, alkyl and aryl functionalized silanes, urea funtionalised silanes or vinyl functionalized silanes.

In one embodiment, the binder composition further comprises a component (v) in form of one or more components selected from the group of bases, such as ammonia, such as alkali metal hydroxides, such as KOH, such as earth alkaline metal hydroxides, such as Ca(OH)₂, such as Mg(OH)₂, such as amines or any salts thereof.

In one embodiment, the binder composition further comprises a further component in form of urea, in particular in an amount of 5 to 40 wt.-%, such as 10 to 30 wt.-%, 15 to 25 wt.-%, based on the dry weight of component (i).

In one embodiment, the binder composition further comprises a further component in form of one or more carbohydrates selected from the group consisting of sucrose, reducing sugars, in particular dextrose, polycarbohydrates, and mixtures thereof, preferably dextrins and maltodextrins, more preferably glucose syrups, and more preferably glucose syrups with a dextrose equivalent value of DE=30 to less than 100, such as DE=60 to less than 100, such as DE=60-99, such as DE=85-99, such as DE=95-99.

In one embodiment, the binder composition further comprises a further component in form of one or more carbohydrates selected from the group consisting of sucrose and reducing sugars in an amount of 5 to 50 wt.-%, such as 5 to less than 50 wt.-%, such as 10 to 40 wt.-%, such as 15 to 30 wt.-% based on the dry weight of component (i).

In the context of the present invention, a binder composition having a sugar content of 50 wt.-% or more, based on the total dry weight of the binder components, is considered to be a sugar based binder. In the context of the present invention, a binder composition having a sugar content of less than 50 wt.-%, based on the total dry weight of the binder components, is considered a non-sugar based binder.

In one embodiment, the binder composition further comprises a further component in form of one or more surface active agents that are in the form of non-ionic and/or ionic emulsifiers such as polyoxyethylenes (4) lauryl ether, such as soy lecithin, such as sodium dodecyl sulfate.

In one embodiment, the aqueous binder composition consists essentially of
a component (i) in form of one or more lignins selected from the group of: lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
   and/or
a component (ii) in form of one or more cross-linkers;
a component (iii) in form of one or more plasticizers;
a component (iv) in form of one or more coupling agents, such as organofunctional silanes;
optionally a component in form of one or more compounds selected from the group of bases, such as ammonia, such as alkali metal hydroxides, such as KOH, such as earth alkaline metal hydroxides, such as Ca(OH)₂, such as Mg(OH)₂, such as amines or any salts thereof;
optionally a component in form of urea;
optionally one or more surface active agents;
water.

In one embodiment, the aqueous binder composition consists essentially of
a component (i) in form of one or more lignins selected from the group of: lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
   and/or
a component (ii) in form of one or more cross-linkers;
a component (iv) in form of one or more coupling agents, such as organofunctional silanes;
optionally a component in form of one or more compounds selected from the group of bases, such as ammonia, such as alkali metal hydroxides, such as KOH, such as earth alkaline metal hydroxides, such as Ca(OH)₂, such as Mg(OH)₂, such as amines or any salts thereof;
optionally a component in form of urea;
optionally one or more surface active agents;
water.

The present inventors have surprisingly found that MMVF cured with an aqueous binder composition as it is described above have at a very high stability, both when freshly produced and after aging conditions.

Further, the present inventors have found that even higher product stability can be obtained by using a curing temperature of >230° C.

In one embodiment, the present invention is therefore directed to a coherent layer comprising MMVF cured with an aqueous binder composition as it is described above, where the curing temperature of >230° C. is used.

The present inventors have further found that the stability of the MMVF product can be further increased by the following measures:
Lower line capacity, meaning longer curing time
Addition of high amounts of crosslinker
Addition of a combination of two or more different crosslinkers
Addition of small amounts of cationic species such as multivalent metal ions such as calcium and/or organic cationic species such as amines and/or organically modified inorganic compounds such as amine modified montmorillonite clays.

The at least one coherent layer generally has a loss on ignition (LOI) within the range of 0.3 to 18.0%, preferably 0.5 to 8.0%.

Preferably the at least one coherent layer comprises 1.0 wt % to 6.0 wt % of cured binder composition, preferably 2.5 wt % to 4.5 wt %, most preferably 3.0 wt % to 3.8 wt % based on the weight of the coherent layer. The advantage associated with this range of 3.0 wt % to 3.8 wt % is that it allows the shock pad to have the required stiffness and elasticity. Determination of binder content is performed according to DS/EN13820:2003. The binder content is taken as the loss on ignition. The binder content includes any binder additives

The coherent layer is hydrophilic, that is, it attracts water. Hydrophilic has its normal meaning in the art.

The hydrophilicity of at least one coherent layer may be defined in terms of the contact angle with water. Preferably, the MMVF of the at least one coherent layer has a contact angle with water of less than 90°. The contact angle is measured by a sessile drop measurement method. Any sessile drop method can be used, for example with a contact angle goniometer. In practice, a droplet is placed on the solid surface and an image of the drop is recorded in time. The static contact angle is then defined by fitting Young-Laplace equation around the droplet. The contact angle is given by the angle between the calculated drop shape function and the sample surface, the projection of which in the drop image is referred to as the baseline. The equilibrium contact angles are used for further evaluation and calculation of the surface free energy using the Owens, Wendt, Rabel and Kaeble method. The method for calculating the contact angle between material and water is well-known to the skilled person.

The hydrophilicity of a sample of MMVF substrate can also be measured by determining the sinking time of a sample. A sample of MMVF substrate having dimensions of 100×100×100 mm is required for determining the sinking time. A container with a minimum size of 200×200×200 mm is filled with water. The sinking time is the time from when the sample first contacts the water surface to the time when the test specimen is completely submerged. The sample is placed in contact with the water in such a way that a cross-section of 100×100 mm first touches the water. The sample will then need to sink a distance of just over 100 mm in order to be completely submerged. The faster the sample sinks, the more hydrophilic the sample is. The MMVF substrate is considered hydrophilic if the sinking time is less than 120 s. Preferably the sinking time is less than 60 s. In practice, the water drainage device may have a sinking time of a few seconds, such as less than 15 seconds.

The advantages of the coherent layer being hydrophilic are that it allows the shock pad to absorb, store and drain water. Using a shock pad according to this embodiment prolongs the usability of the artificial sports field as the shock pad absorbs water, and stores the water thus improving the sports performance of the sports field, without the need for a plastics infill layer. The shock pad can actively prevent or treat flooding by absorbing water. The shock pad according to the present invention can prolong usability of the sports field by decreasing the surface temperature i.e. surface cooling. This is because the shock pad can store water and can transport it upwards to the infill layer, if present, or in direct contact with the air for evaporation. Therefore, the area between the sports field surface (i.e. artificial grass) remains moist and the temperature is kept stable through evaporation.

The coherent layer of the shock pad according to the invention may optionally comprise a wetting agent. A wetting agent has its normal meaning in the art, and may be a cationic, anionic or non-ionic surfactant.

The coherent layer of the shock pad may comprise a non-ionic wetting agent such as Rewopal®.

The coherent layer of the shock pad may comprise an ionic surfactant, more preferably an alkyl ether sulphate surfactant wetting agent. The wetting agent may be an alkali metal alkyl ether sulphate or an ammonium alkyl ether sulphate. Preferably the wetting agent is a sodium alkyl ether sulphate. A commercially available alkyl ether sulphate surfactant wetting agent is Texapon®. The wetting agent may also be a linear alkyl benzene sulphonate anionic surfactant.

Some non-ionic wetting agents may be washed out of the coherent layer of the shock pad over time. It is therefore preferable to use an ionic wetting agent, especially an anionic wetting agent, such as linear alkyl benzene sulphonate or Texapon®. These do not wash out of the coherent layer of the shock pad to the same extent.

The coherent layer of the shock pad may comprise 0.01 to 1 wt % wetting agent, preferably 0.05 to 0.5 wt % wetting agent, more preferably 0.1 to 0.3 wt % wetting agent.

However, the inventors discovered that a wetting agent is not essential for the coherent layer of the shock pad according to the invention. This is believed to be due to the nature of the binder composition. Therefore, preferably the coherent layer of the shock pad does not comprise any wetting agent. By this, it is meant that the coherent layer of the shock pad preferably comprises no wetting agent i.e. comprises 0 wt % wetting agent.

This has several advantages. Firstly, it reduces the number of additives in the shock pad which is environmentally advantageous, and also saves costs. Often wetting agents are made from non-renewable sources so it is beneficial to avoid their use. Additionally, wetting agents may be washed out of the shock pad. This is problematic because the wetting agent may contaminate the surrounding ground. When a wetting agent is washed out this also changes the nature of the coherent layer of the shock pad, typically changing buffering, drainage and infiltration, making it difficult to predict the behaviour. Avoiding the use of a wetting agent avoids these problems.

Preferably the water holding capacity of the coherent layer is at least 50% of the volume of the coherent layer, preferably at least 60%, most preferably at least 70% or at least 80%. The greater the water holding capacity, the more water can be stored for a given coherent layer volume. The water holding capacity of the coherent layer is high due to the open pore structure of the MMVF.

Preferably the amount of water that is retained by the coherent layer when it emits water is less than 20% vol, preferably less than 10% vol, most preferably less than 5% vol based on the volume of the coherent layer. The water retained may be 2 to 20% vol, such as 5 to 10% vol. The lower the amount of water retained by the coherent layer, the greater the capacity of the coherent layer to take on more water.

Preferably the buffering capacity of the coherent layer, that is the difference between the maximum amount of water that can be held, and the amount of water that is retained when the coherent layer gives off water, is at least 60% vol, preferably at least 70% vol, preferably at least 80% vol. The buffering capacity may be 60 to 90% vol, such as 60 to 85% vol based on the volume of the coherent layer. The advantage of such a high buffering capacity is that the coherent layer can buffer more water for a given volume, that is the coherent layer can store a high volume of water when required, and release a high volume of water to the infill layer, if present, or by evaporation from the surface. The buffering capacity is so high because MMVF substrate requires a low suction pressure to remove water from the MMVF coherent layer.

The water holding capacity, the amount of water retained and the buffering capacity of the coherent layer can each be measured in accordance with EN 13041:1999.

Preferably, the at least one coherent layer is substantially free from oil. Most preferably the coherent layer is free from oil. By this it is meant that the coherent layer has 0 wt % of oil. Oil is typically added to MMVF substrates which are to be used for purposes such as sound, insulation, thermal insulation and fire protection. However, the inventors have surprisingly discovered that the coherent plate is sufficiently hydrophilic to absorb and drain water when it is free from oil or substantially free from oil.

Hydrophilicity of the coherent layer may be defined by the hydraulic conductivity. Preferably, the at least one coherent layer has a hydraulic conductivity of 5 m/day to 200 m/day, preferably 10 m/day to 50 m/day. Hydraulic conductivity is measured in accordance with ISO 17312:2005. The advantage of this hydraulic conductivity is that the shock pad can absorb excess water and transfer it away from the sports field with sufficient speed to prevent flooding. As discussed above, this may be achieved by having a coherent plate that is free from or substantially free from oil and/or by having a binder in accordance with the invention.

The at least one coherent layer may be made by any of the methods known to those skilled in the art for production of MMVF products. In general, a mineral charge is provided, which is melted in a furnace to form a mineral melt. The melt is then formed into fibres by means of centrifugal fiberisation e.g. using a spinning cup or a cascade spinner, to form a cloud of fibres. These fibres are then collected and consolidated. Binder is usually added at the fiberisation stage by spraying into the cloud of forming fibres. These methods are well known in the art.

In one embodiment, the coherent plate comprises only one coherent layer. Preferably, the one coherent layer forms the coherent plate i.e. no further layers are present.

In another embodiment, the coherent plate may comprise at least two coherent layers: a first coherent layer and a further coherent layer. This embodiment is shown in FIG. 2. The shock pad (10) comprises a coherent plate (20) having upper and lower major surfaces wherein the coherent plate comprises at least one coherent layer (30a) comprising man-made vitreous fibres (MMVF) bonded with a cured binder composition. The coherent plate (20) further comprises a further coherent layer (30b) comprising man-made vitreous fibres (MMVF) bonded with a cured binder composition in accordance with the invention.

The shock pad may further comprise an upper membrane layer (40a) bonded to the upper major surface of the coherent plate (20) and a lower membrane layer (40b) bonded to the lower major surface of the coherent plate (20).

In this embodiment, the first coherent layer is preferably as described above i.e. the at least one coherent layer. The advantage of having a coherent plate with two coherent layers is that it can be used to improve durability of the shock pad whilst meeting the requirements for sports performance (e.g. shock absorption and energy restitution).

In this embodiment, the further coherent layer preferably has a thickness in the range of 3 mm to 10 mm, preferably 5 mm to 8 mm. This means that, when the coherent plate comprises two coherent layers, the total thickness of the coherent plate if preferably 15 mm to 50 mm.

In this embodiment, the further coherent layer preferably has a density in the range of 175 kg/m³ to 300 kg/m³, preferably 200 kg/m³ to 260 kg/m³, most preferably 235 kg/m³. Preferably, the further coherent layer has a different density to that of the first coherent layer. Preferably, the further coherent layer has a lower density to that of the first coherent layer.

In this embodiment, the further coherent layer and the first coherent layer are preferably bonded together. This may be achieved by producing the two layers simultaneously and curing them together. Preferably the further coherent layer is positioned below the first coherent layer. Preferably, the further coherent layer forms the lower surface of the coherent plate and the first coherent layer forms the upper surface of the coherent plate.

In another embodiment, the bonding together of the further coherent layer and the first coherent layer may be achieved by using an adhesive. The binder as described herein may be used as the adhesive to bond the further coherent layer and the first coherent layer together.

The further coherent layer may have any of the above described preferable features of the at least one coherent layer.

Preferably the further coherent layer comprises 1.0 wt % to 6.0 wt % of cured binder composition, preferably 2.5 wt % to 4.5 wt %, most preferably 3.0 wt % to 3.8 wt % based on the weight of the coherent layer. The advantage associated with this range of 3.0 wt % to 3.8 wt % is that it allows the shock pad to have the required stiffness and elasticity.

Preferably, the coherent layer is hydrophilic, that is, it attracts water. The hydrophilicity of a sample of MMVF substrate can be measured as described above for the at least one coherent layer.

The advantages of the further coherent layer being hydrophilic are that it allows the shock pad to absorb, store and drain water. Using a shock pad according to this embodiment prolongs the usability of the artificial sports field as the shock pad absorbs water, and stores the water thus improving the sports performance of the sports field.

The shock pad can actively prevent or treat flooding by absorbing water. The shock pad according to the present invention can prolong usability of the sports field by decreasing the surface temperature i.e. surface cooling. This is because the shock pad can store water and can transport it upwards to the infill layer, if present, or in direct contact with the air for evaporation. Therefore, the area between the sports field surface (i.e. artificial grass) remains moist and the temperature is kept stable through evaporation.

The further coherent layer of the shock pad may comprise 0.01 to 1 wt % wetting agent, preferably 0.05 to 0.5 wt % wetting agent, more preferably 0.1 to 0.3 wt % wetting agent. However, the inventors discovered that a wetting agent is not essential for the coherent layer of the shock pad according to the invention. This is believed to be due to the nature of the binder composition. Therefore, preferably the further coherent layer of the shock pad does not comprise any wetting agent. By this, it is meant that the further coherent layer of the shock pad preferably comprises no wetting agent i.e. comprises 0 wt % wetting agent. This is beneficial as it avoids any added wetting agent leaching out into the surrounding area.

The hydrophilicity of the further coherent layer may be defined in terms of the contact angle with water. Preferably, the MMVF of the further layer has a contact angle with water of less than 90°. The contact angle is measured as described above.

Preferably, the further coherent layer is substantially free from oil. Most preferably the further coherent layer is free from oil. By this it is meant that the further coherent layer has 0 wt % of oil. Oil is typically added to MMVF substrates which are to be used for purposes such as sound, insulation, thermal insulation and fire protection. However, the inventors have surprisingly discovered that the coherent plate is sufficiently hydrophilic to absorb and drain water when it is free from oil or substantially free from oil. In this embodiment, the binder composition may be hydrophilic, amphiphilic or hydrophobic, as discussed above. Preferably, when the binder composition is hydrophobic or amphiphilic, the coherent plate is free from or substantially free from oil.

Hydrophilicity of the coherent layer may be defined by the hydraulic conductivity. Preferably, the further coherent layer has a hydraulic conductivity of 5 m/day to 200 m/day, preferably 10 m/day to 50 m/day. Hydraulic conductivity is measured in accordance with ISO 17312:2005. The advantage of this hydraulic conductivity is that the shock pad can absorb excess water and transfer it away from the sports field with sufficient speed to prevent flooding. As discussed above, this may be achieved by having a coherent plate that is free from or substantially free from oil and/or the binder according to the invention.

In a preferred embodiment, the at least one coherent layer has a thickness of 15 mm and a density of 275 kg/m³; and the further coherent layer has a thickness of 5 to 8 mm and a density of 235 kg/m³. The advantage of this embodiment is that durability of the shock pad can be improved whilst meeting the requirements for sports performance (e.g. shock absorption and energy restitution). The top layer improves durability and the bottom layer optimises the shock absorption and energy restitution.

Preferably the coherent plate is hydrophilic. This can be achieved as described above for the at least one coherent layer.

Preferably the coherent plate is vertically compressed by less than 10%, more preferably by 1% to 9%, most preferably by 3% to 8% of its original vertical thickness. This is achieved by compression treatment or pre-treatment. The advantage of this treatment is that the shock pad will deform less when in position in the sports fields i.e. it results in a reduced vertical deformation. The criteria that must be met for football and hockey artificial fields include a specific vertical deformation value. The inventors surprisingly discovered that subjecting the coherent plate to a compression treatment, in which it is compressed by less than 10% of its original vertical thickness, reduces the vertical deformation value of the shock pad in use.

The compression treatment may be carried out by any method, however, it is preferred that the coherent plate is subjected to compression treatment by rolling through one or more pairs of rollers.

The coherent plate according to the present invention may be bonded to an upper membrane layer and/or a lower membrane layer. The upper membrane layer may be bonded to the upper major surface of the coherent plate. The lower membrane layer may be bonded to the lower major surface of the coherent plate.

The advantage of having an upper membrane layer is that it absorbs the point loads from above. For example, when the sports field is in use, this will put pressure on the shock pads. The upper membrane layer allows the shock pad to meet the strict requirements of hockey and football artificial pitches.

The advantage of having a lower membrane layer is that it absorbs the point loads from below. For example, the shock pad may be positioned in the ground on an uneven surface, such as on a layer of gravel. When the sports field is in use, this will create point loads on the bottom layer of the shock pad. The lower membrane layer allows the shock pad to meet the strict requirements of hockey and football artificial pitches.

The advantage of having the upper and lower membrane layers bonded to the coherent layer is that it gives a significantly higher resistance to point loads compared to non-attached membranes. It is also easier to install a single product, which simplifies the installation process.

In one embodiment, the upper membrane layer and the lower membrane are glued or heat melted to the coherent plate. In this embodiment, preferably ethylene vinyl acetate (EVA) or polyethylene (PE) glue is used to bond the upper and lower membrane layers to the coherent plate.

In one embodiment, the upper membrane layer and the lower membrane are bonded to the coherent plate by placing a binder between the membrane layer and coherent plate, and curing the binder. The binder is preferably as described herein. The inventors have discovered that using a binder as described in to bonded the upper membrane layer and the lower membrane to the coherent plate results in a very strong bond, with a high peel strength.

In one embodiment, the upper membrane layer and the lower membrane are bonded to the coherent plate by placing them in contact before the binder of the coherent plate is cured. When curing occurs, the membranes will adhere to the coherent layer. The inventors have discovered that the binder as described herein results in very good adhesion of the upper and lower membrane to the coherent layer when cured in this way.

Preferably, the upper membrane layer extends across and is bonded to the entire upper surface of the coherent plate. Preferably, the lower membrane layer extends across and is bonded to the entire lower surface of the coherent plate. This results in a more stable and durable shock pad.

Preferably, the upper membrane layer comprises glass fibres, polymer fibres, glass microfibers or a mixture thereof. Most preferably it comprises a layer of glass fibres, preferably non-woven glass fibres.

In addition, the upper membrane layer preferably comprises a mesh layer, wherein the mesh layer comprises glass fibres, polymer fibres or a mixture thereof. Most preferably the upper membrane layer comprises a mesh of glass fibres, wherein the yarn in the mesh has 25 tex to 40 tex, more preferably 32 tex to 36 tex.

Preferably, the upper membrane layer comprises a layer of non-woven glass fibres and a mesh layer which are integrated i.e. bonded together.

Preferably, the lower membrane layer comprises glass fibres, polymer fibres, glass microfibers or a mixture thereof.

The present invention relates to a shock pad for use in artificial sports fields. The shock pad is as described above. It may have any of the additional features described herein.

The present invention also relates to a method of producing a shock pad. The method comprises the steps of:
(i) providing man-made vitreous fibres;
(ii) spraying the man-made vitreous fibres with an aqueous binder composition free of phenol and formaldehyde;
(iii) collecting and consolidating the man-made vitreous fibres and curing the aqueous binder composition to form a coherent layer;
(iv) providing a coherent plate having upper and lower major surfaces, wherein the coherent plate comprises at least one coherent layer;
   wherein the binder composition prior to curing comprises:
a component (i) in form of one or more lignosulfonate lignins having a carboxylic acid group content of 0.03 to 1.4 mmol/g, based on the dry weight of the lignosulfonate lignins,
a component (ii) in form of one or more cross-linkers.

The shock pad may have any of the additional features discussed in detail above. The binder composition may have any of the features described above.

Man-made vitreous fibres can be made from a mineral melt. A mineral melt is provided in a conventional manner by providing mineral materials and melting them in a furnace. This furnace can be any of the types of furnace known for production of mineral melts for MMVF, for instance a shaft furnace such as a cupola furnace, a tank furnace, electric furnace or a cyclone furnace.

Any suitable method may be employed to form MMVF from the mineral melt by fiberization. The fiberization can be by a spinning cup process in which melt is centrifugally extruded through orifices in the walls of a rotating cup (spinning cup or disk fiberization, also known as internal centrifugation). Alternatively, the fiberization can be by centrifugal fiberization by projecting the melt onto and spinning off the outer surface of one fiberizing rotor, or off a cascade of a plurality of fiberizing rotors, which rotate about a substantially horizontal axis (cascade spinner).

The melt is thus formed into a cloud of fibres entrained in air and the fibres are collected as a web on a conveyor and carried away from the fiberizing apparatus. The web of fibres is then consolidated, which can involve cross-lapping and/or longitudinal compression and/or vertical compression and/or winding around a mandrel to produce a cylindrical product for pipe insulation. Other consolidation processes may also be performed.

The binder composition is applied to the fibres preferably when they are a cloud entrained in air. Alternatively, it can be applied after collection on the conveyor but this is less preferred.

Generally, the binder is sprayed immediately after fibrillation of the mineral melt on to the air-borne mineral fibres. The aqueous binder composition is normally applied in an amount of 0.1 to 18%, preferably 0.2 to 8% by weight, of the bonded MMVF product on a dry basis.

After consolidation the consolidated web of fibres is passed into a curing device to cure the binder. The spray-coated mineral fibre web is generally cured in a curing oven by means of a hot air stream. The hot air stream may be introduced into the mineral fibre web from below, or above or from alternating directions in distinctive zones in the length direction of the curing oven. The web is cured by a chemical and/or physical reaction of the binder components.

In one embodiment, the curing is carried out at temperatures from 100 to 300° C., such as 170 to 270° C., such as 180 to 250° C., such as 190 to 230° C.

Further, the present inventors have found that even higher product stability can be obtained by using a curing temperature of >230° C. Therefore, in one embodiment, a curing temperature of >230° C. is used.

In a preferred embodiment, the curing takes place in a conventional curing oven for mineral wool production, preferably operating at a temperature of from 150 to 300° C., such as 170 to 270° C., such as 180 to 250° C., such as 190 to 230° C.

In one embodiment, the curing takes place for a time of 30 seconds to 20 minutes, such as 1 to 15 minutes, such as 2 to 10 minutes.

The curing process may commence immediately after application of the binder to the fibres. The curing is defined as a process whereby the binder composition undergoes a physical and/or chemical reaction which in case of a chemical reaction usually increases the molecular weight of the compounds in the binder composition and thereby increases the viscosity of the binder composition, usually until the binder composition reaches a solid state. The cured binder composition binds the fibres to form a structurally coherent matrix of fibres.

In a one embodiment, the curing of the binder in contact with the mineral fibres takes place in a heat press.

The curing of a binder in contact with the mineral fibres in a heat press has the particular advantage that it enables the production of high-density products.

In one embodiment the curing process comprises drying by pressure. The pressure may be applied by blowing air or gas through/over the mixture of mineral fibres and binder.

Preferably, the method according to the present invention further comprises the step of pre-treating the coherent plate by compression, wherein the compression vertically deforms the coherent plate by less than 10%, preferably by 1% to 9%, preferably by 3% to 8%. This is achieved by compression treatment or pre-treatment. The advantage of this treatment is that the shock pad will deform less when in position in the sports fields i.e. it results in a reduced vertical deformation. The criteria which must be met for football and hockey artificial fields include a specific vertical deformation value. The inventors surprisingly discovered that subjecting the coherent plate to a compression treatment, in which it is compressed by less than 10% of its original vertical thickness, reduces the vertical deformation value of the shock pad in use.

The compression treatment may be carried out by any method, however, it is preferred that the coherent plate is subjected to compression treatment by rolling through one or more pairs of rollers.

The method may also include the steps of:
(i) bonding the upper membrane layer to the upper surface of the coherent plate; and/or
(ii) bonding the lower membrane layer to the lower surface of the coherent plate

In one embodiment, the bonding in step (i) and/or step (ii) is by a glue or adhesive.

In an alternative embodiment, the bonding in step (i) and/or step (ii) is by placing a binder between the membrane layer and coherent plate, and curing the binder. Preferably, the binder is as described herein.

The present invention also relates to a method of using a shock pad to provide a shock-absorbing surface in a sports field, comprising the step of: positioning a shock pad or an array of shock pads beneath the surface of a sports field, wherein the shock pad comprises: a coherent plate having upper and lower major surfaces, wherein the coherent plate comprises at least one coherent layer comprising man-made vitreous fibres (MMVF) bonded with a cured aqueous binder composition free of phenol and formaldehyde; wherein the aqueous binder composition prior to curing comprises:
a component (i) in form of one or more lignosulfonate lignins having a carboxylic acid group content of 0.03 to 1.4 mmol/g, based on the dry weight of the lignosulfonate lignins,
a component (ii) in form of one or more cross-linkers.

The shock pad may have any of the additional features discussed in detail above.

The present invention also relates to use of a shock pad for absorbing shock in a sports field, wherein the shock pad comprises: a coherent plate having upper and lower major surfaces, wherein the coherent plate comprises at least one coherent layer comprising man-made vitreous fibres (MMVF) bonded with a cured aqueous binder composition free of phenol and formaldehyde; wherein the aqueous binder composition prior to curing comprises:
a component (i) in form of one or more lignosulfonate lignins having a carboxylic acid group content of 0.03 to 1.4 mmol/g, based on the dry weight of the lignosulfonate lignins,
a component (ii) in form of one or more cross-linkers.

The shock pad may have any of the additional features discussed in detail above.

The present invention also relates to use of a shock pad for absorbing and/or draining water in a sports field, wherein the shock pad comprises: a coherent plate having upper and lower major surfaces, wherein the coherent plate comprises at least one coherent layer comprising man-made vitreous fibres (MMVF) bonded with a cured aqueous binder composition free of phenol and formaldehyde; wherein the aqueous binder composition prior to curing comprises:
a component (i) in form of one or more lignosulfonate lignins having a carboxylic acid group content of 0.03 to 1.4 mmol/g, based on the dry weight of the lignosulfonate lignins,
a component (ii) in form of one or more cross-linkers.

The shock pad may have any of the additional features discussed in detail above.

The shock pad may absorb rainwater from above ground, or it may absorb water provided by an underground irrigation system. In times of excess rainwater, the shock pad can drain water to a lower sub-base level. The shock pad provides horizontal drainage which means that water can be drained and collected at the sides of the sports field.

The present invention also relates to use of a shock pad for cooling the surface temperature of a sports field, wherein the shock pad comprises: a coherent plate having upper and lower major surfaces, wherein the coherent plate comprises at least one coherent layer comprising man-made vitreous fibres (MMVF) bonded with a cured aqueous binder composition free of phenol and formaldehyde; wherein the aqueous binder composition prior to curing comprises:
a component (i) in form of one or more lignosulfonate lignins having a carboxylic acid group content of 0.03 to 1.4 mmol/g, based on the dry weight of the lignosulfonate lignins,
a component (ii) in form of one or more cross-linkers.

The shock pad may have any of the additional features discussed in detail above.

The term “cooling” has its normal meaning in the art i.e. reducing the temperature. By this, it is meant reducing the temperature of the sports field and its surroundings. This is achieved by the shock pad layer absorbing water, for example rain water from above the ground or from an underground irrigation system. This water is held in the shock pad and transferred to the surface where it evaporates due to air temperature and wind.

The present invention relates to a sports field comprising:
(i) a lower base layer;
(ii) an upper grass and/or artificial grass layer;
(iii) a shock pad layer, positioned between the base layer and the grass or artificial grass layer;
   wherein the shock pad layer comprises at least one shock pad comprising a coherent plate having upper and lower major surfaces, wherein the coherent plate comprises at least one coherent layer comprising man-made vitreous fibres (MMVF) bonded with a cured aqueous binder composition free of phenol and formaldehyde; wherein the aqueous binder composition prior to curing comprises:
a component (i) in form of one or more lignosulfonate lignins having a carboxylic acid group content of 0.03 to 1.4 mmol/g, based on the dry weight of the lignosulfonate lignins,
a component (ii) in form of one or more cross-linkers.

The shock pad may have any of the additional features discussed in detail above.

The present inventors discovered that the shock pad in accordance with the invention can be used to form a sports field that does not require the use of a plastic infill layer. This is due to the fact that the shock pad can absorb and store water. The shock pad holding water means that the required play performance can be met without the need for a plastics infill layer. Therefore, this results in the numerous benefits described above. Without the need for a plastic infill layer, there is no contamination of the environment, including marine environment, from microplastics.

Preferably, the base layer comprises stone, more preferably compacted crushed stone or concrete. Preferably the base layer is 20 to 50 cm in depth. Preferably the base layer is applied to a levelled ground layer.

The upper layer may comprise grass, artificial or a combination of grass and artificial grass. Preferably, the upper layer comprises artificial grass. It may be 100% artificial grass or it may be a hybrid turf comprising both natural grass and synthetic grass. Preferably this layer is 40 to 70 mm in depth. The artificial grass fibres are preferably supplied in the form of mats, but can be made on site by tufting the artificial grass into the substrate layer above the shock pad. The artificial grass fibres are preferably made of synthetic fibres which optionally can be coated with silicone.

This is shown in FIG. 3. The shock pad layer (100) as described herein is positioned above a base layer (200). A top layer of grass or artificial grass (300) is then be positioned above the shock pad.

The sports field may also further comprise (iv) an infill layer between the shock pad layer and the grass or artificial grass layer or in the grass or artificial grass layer, wherein the infill layer comprises sand or non-plastic material. The optional infill layer is primarily for stabilising the grass or artificial grass, and is not in particular required to meet the sports performance requirements. The weight of the sand or non-plastic material prevents the grass or artificial grass layer from being moved out of position and keeps the grass fibres in place.

Non-plastic material includes silica granules, cork or biomaterial such as granulated corn cobs.

Preferably, the infill layer does not comprise any plastic material, by this it is meant that it comprises less than 5% plastic, preferably less than 2% preferably less than 1% plastic.

The present invention also relates to a method of producing a sports field, comprising the steps of:
(i) providing a lower base layer;
(ii) providing a shock pad layer above the base layer;
(iii) providing an upper grass and/or artificial grass layer above the shock pad layer;
   wherein the shock pad layer comprises at least one shock pad comprising a coherent plate having upper and lower major surfaces, wherein the coherent plate comprises at least one coherent layer comprising man-made vitreous fibres (MMVF) bonded with a cured aqueous binder composition free of phenol and formaldehyde; wherein the aqueous binder composition prior to curing comprises:
a component (i) in form of one or more lignosulfonate lignins having a carboxylic acid group content of 0.03 to 1.4 mmol/g, based on the dry weight of the lignosulfonate lignins,
a component (ii) in form of one or more cross-linkers.

The shock pad may have any of the additional features discussed in detail above.

The present invention also relates to use of a lignin component in form of one or more lignosulfonate lignins having a carboxylic acid group content of 0.03 to 1.4 mmol/g, based on the dry weight of the lignosulfonate lignins, for the preparation of a binder composition free of phenol and formaldehyde for a coherent plate of a shock pad comprising man-made vitreous fibres (MMVF).

In one embodiment, the binder composition is free of phenol and formaldehyde.

In one embodiment, the present invention is directed to the use of a lignin component in the form of one or more lignosulfonate lignins having the features of component (i) described above for the preparation of a binder composition, preferably free of phenol and formaldehyde, for a coherent growth substrate product comprising man-made vitreous fibres (MMVF), whereby this binder composition further comprises components (ii) and optionally (iii) as defined above, preferably with the proviso that the aqueous binder composition does not comprise a cross-linker selected from
epoxy compounds having a molecular weight M_{w} of 500 or less
   and/or
   with the proviso that the aqueous binder composition does not comprise a cross-linker selected from
carbonyl compounds selected from aldehydes, carbonyl compounds of the formula R—[C(O)R₁]ₓ
   in which:
R represents a saturated or unsaturated and linear, branched or cyclic hydrocarbon radical, a radical including one or more aromatic nuclei which consist of 5 or 6 carbon atoms, a radical including one or more aromatic heterocycles containing 4 or 5 carbon atoms and an oxygen, nitrogen or sulfur atom, it being possible for the R radical to contain other functional groups,
R₁ represents a hydrogen atom or a C₁-C₁₀ alkyl radical, and x varies from 1 to 10
and/or
with the proviso that the aqueous binder composition does not comprise a cross-linker selected from
   polyamines
and/or
with the proviso that the aqueous binder composition does not comprise a cross-linker selected from
   mono- and oligosaccharides.

In one embodiment, the present invention is directed to the use of a lignin component in form of one or more lignosulfonate lignins having the features of component (i) described above for the preparation of a binder composition, preferably free of phenol and formaldehyde, whereby the binder composition further comprises component (iia) as defined above.

The shock pad may have any of the additional features discussed in detail above.

### EXAMPLES

In the following examples, several binders which fall under the definition of the present invention were prepared and compared to binders according to the prior art. The following properties were determined for the binders according to the present invention and the binders according to the prior art, respectively:

### Binder Component Solids Content

The content of each of the components in a given binder solution before curing is based on the anhydrous mass of the components.

Lignosulfonates were supplied by Borregaard, Norway and LignoTech, Florida as liquids with approximately 50% solid content. Primid XL552 was supplied by EMS-CHEMIE AG, Silane (Momentive VS-142 40% activity), was supplied by Momentive and was calculated as 100% for simplicity. NH40H 24.7% was supplied by Univar and used in supplied form. PEG 200, urea, KOH pellets, 1,1,1 tris(hydroxymethyl)propane were supplied by Sigma-Aldrich and were assumed anhydrous for simplicity.

### Binder Solids

The content of binder after curing is termed “binder solids”.

Disc-shaped stone wool samples (diameter: 5 cm; height 1 cm) were cut out of stone wool and heat-treated at 580° C. for at least 30 minutes to remove all organics. The solids of the binder mixture was measured by distributing a sample of the binder mixture (approx. 2 g) onto a heat treated stone wool disc in a tin foil container. The weight of the tin foil container containing the stone wool disc was weighed before and directly after addition of the binder mixture. Two such binder mixture loaded stone wool discs in tin foil containers were produced and they were then heated at 200° C. for 1 hour. After cooling and storing at room temperature for 10 minutes, the samples were weighed and the binder solids was calculated as an average of the two results.

A binder with a desired binder solids could then be produced by diluting with the required amount of water and 10% aq. silane (Momentive VS-142).

### Example 1: Water Absorption

Water absorption was measured in accordance with EN1609:2013 for four different binder compositions, as shown in Table 1 below. The testing was performed using four individual test specimens in 200×200 mm in full product thickness to get one result

Comparative Binder 1, a PUF binder, was made as follows:

A phenol-formaldehyde resin is prepared by reacting 37% aq. formaldehyde (606 g) and phenol (189 g) in the presence of 46% aq. potassium hydroxide (25.5 g) at a reaction temperature of 84° C. preceded by a heating rate of approximately 1° C. per minute. The reaction is continued at 84° C. until the acid tolerance of the resin is 4 and most of the phenol is converted. Urea (241 g) is then added and the mixture is cooled.

The acid tolerance (AT) expresses the number of times a given volume of a binder can be diluted with acid without the mixture becoming cloudy (the binder precipitates). Sulfuric acid is used to determine the stop criterion in a binder production and an acid tolerance lower than 4 indicates the end of the binder reaction.

To measure the AT, a titrant is produced from diluting 2.5 ml conc. sulfuric acid (>99%) with 1 L ion exchanged water. 5 mL of the binder to be investigated is then titrated at room temperature with this titrant while keeping the binder in motion by manually shaking it; if preferred, use a magnetic stirrer and a magnetic stick. Titration is continued until a slight cloud appears in the binder, which does not disappear when the binder is shaken.

The acid tolerance (AT) is calculated by dividing the amount of acid used for the titration (mL) with the amount of sample (mL):

$$AT = ( Used titration volume ( mL ) ) / ( Sample volume ( mL ) )$$

Using the urea-modified phenol-formaldehyde resin obtained, a binder is made by addition of 25% aq. ammonia (90 mL) and ammonium sulfate (13.2 g) followed by water (1.30 kg).

The binder solids were then measured as described above and the mixture was diluted with the required amount of water and silane (15% binder solids solution, 0.5% silane of binder solids).

Comparative Binder 2 was made as follows:

3267 kg of water is charged in 6000 l reactor followed by 287 kg of ammonia water (24.7%). Then 1531 kg of Lignin UPM BioPiva 100 is slowly added over a period of 30 min to 45 min. The mixture is heated to 40° C. and kept at that temperature for 1 hour. After 1 hour a check is made on insolubilized lignin. This can be made by checking the solution on a glass plate or a Hegman gauge. Insolubilized lignin is seen as small particles in the brown binder. During the dissolution step will the lignin solution change color from brown to shiny black. After the lignin is completely dissolved, 1 liter of a foam dampening agent (Skumdomper 11-10 from NCA-Verodan) is added. Temperature of the batch is maintained at 40° C. Then addition of 307.5 kg 35% hydrogen peroxide is started. The hydrogen peroxide is dosed at a rate of 200-300 l/h. First half of the hydrogen peroxide is added at a rate of 200 I/h where after the dosage rate is increased to 300 l/h.

During the addition of hydrogen peroxide is the temperature in the reaction mixture controlled by heating or cooling in such a way that a final reaction temperature of 65° C. is reached.

The final product was analysed for the COOH group content, dry solid matter, pH, viscosity and remaining H₂O₂·60 g of this oxidized lignin (18.2% solids) was mixed with 1.4 g Primid XL552 (100% solids) and 2.8 g PEG200 (100% solids). 0.6 g Silane (Momentive VS-142 40% activity, 10% in water) and 17.4 g water were added and mixed to yield 15% solids.

Binder 1, according to the invention, was made as follows:

600.0 kg of ammonium lignosulfonate was placed in a mixing vessel to which 8.0 litres NH₄OH (24.7%) was added and stirred. Afterwards, 190 kg Primid XL552 solution (pre-made 31 wt % solution in water) and 68 kg PEG 200 (100% solids) were added and mixed followed by addition of 11 kg Silane (Momentive VS-142 40% activity, 10% in water).

Binder 2, according to the invention, was made as follows:

730.0 kg of ammonium lignosulfonate was placed in a mixing vessel to which 8.5 l NH40H (24.7%) was added and stirred. Afterwards, 151 kg Primid XL552 solution (pre-made 31 wt % solution in water) and 43 kg PEG 200 (100% solids) were added and mixed followed by addition of 13 kg Silane (Momentive VS-142 40% activity, 10% in water).

The results are shown below in Table 1.

As can be seen from Table 1, the water absorption for binders according to the invention is significantly higher than for the PUF binder or for the comparative lignin-based formaldehyde free binder.

TABLE 1

| Binder | water abs kg/m2 24 h |
|---|---|
| Comparative Binder 1 (PUF) | 0.10 |
| Comparative Binder 2 (lignin | 0.20 |
| based Formaldehyde free) | |
| Binder 1 | 0.60 |
| Binder 2 | 0.70 |

### Example 2: Wet Strength

Wet strength was determined by submerging bars into water for four days at room temperature. The strength is measured within 20 minutes after taking out the bars from the water.

The bars were made as follows. For each binder, 16 bars were manufactured from a mixture of the binder and stone wool shots from the stone wool spinning production.

A sample of this binder solution having 15% dry solid matter (16.0 g) was mixed well with shots (80.0 g). The resulting mixture was then filled into four slots in a heat resistant silicone form for making small bars (4×5 slots per form; slot top dimension: length=5.6 cm, width=2.5 cm; slot bottom dimension: length=5.3 cm, width=2.2 cm; slot height=1.1 cm). The mixtures placed in the slots were then pressed with a suitably sized flat metal bar to generate even bar surfaces. 16 bars from each binder were made in this fashion. The resulting bars were then cured typically at 225° C. The curing time was 1 h. After cooling to room temperature, the bars were carefully taken out of the containers.

The bars were broken in a 3 point bending test (test speed: 10.0 mm/min; rupture level: 50%; nominal strength: 30 N/mm2; support distance: 40 mm; max deflection 20 mm; nominal emodule10000 N/mm2) on a Bent Tram machine to investigate their mechanical strengths. The bars were placed with the “top face” up (i.e. the face with the dimensions length=5.6 cm, width=2.5 cm) in the machine.

The binder according to the invention, Binder 2, is as described above for Example 1.

Comparative Binder 3 was made as follows:

A mixture of 75.1% aq. glucose syrup (19.98 g; thus efficiently 15.0 g glucose syrup), 50% aq. hypophosphorous acid (0.60 g; thus efficiently 0.30 g, 4.55 mmol hypophosphorous acid) and sulfamic acid (0.45 g, 4.63 mmol) in water (30.0 g) was stirred at room temperature until a clear solution was obtained.

28% aq. ammonia (0.80 g; thus efficiently 0.22 g, 13.15 mmol ammonia) was then added dropwise until pH=7.9. The binder solids was then measured (21.2%).

The binder mixture was diluted with water (0.403 g/g binder mixture) and 10% aq. silane (0.011 g/g binder mixture, Momentive VS-142). The final binder mixture for mechanical strength studies had pH=7.9.

Comparative Binder 1, the PUF binder, was made as described above for Example 1.

The results are shown in Table 2. As can be seen from Table 2, the wet strength of the binder according to the invention (Binder 2) was slightly lower than that of PUF, but higher than that of a comparative formaldehyde-free binder.

TABLE 2

| | | Comparative Binder 3 | Comparative |
|---|---|---|---|
| | | (sugar-based | Binder 1 |
| Binder | Binder 2 | formaldehyde free) | (PUF) |
| wet strength | 0.18 ± 0.04 | 0.15 ± 0.02 | 0.23 ± 0.08 |

### Example 3: Delamination Strength after Aging

The delamination strength after aging was measured in accordance with EN1607:2013. Aging of the MMVF test specimens was achieved by exposing them to heat-moisture action for 7 days at 70±2° C. and 95±5% relative humidity in climatic chamber.

Three different binders were tested.

Comparative Binder 1 is as described above for Example 1. It is a PUF binder.

Comparative Binder 3 is as described above. It is a sugar-based binder.

Binder 2 is according to the invention, as described above.

The results are shown below in Table 3. As can be seen from Table 3 and, the delamination strength in percentage after 28 days for the product with the binder of the invention (Binder 2) is improved in comparison to another formaldehyde-free binder (Comparative Binder 3) and similar to that of PUF.

TABLE 3
delamination in % of initial (days)

| | 0 | 7 | 14 | 28 |
|---|---|---|---|---|
| Comparative | 100 | 67.1 | 64.7 | 62.0 |
| Binder 1 (PUF) | | | | |
| Comparative | 100 | 54.2 | 55.0 | 45.8 |
| Binder 3 | | | | |
| Binder 2 | 100 | 70.8 | 66.7 | 57.7 |

### Example 4—Peel Strength

A glass fiber nonwoven Evalith DH 50/20 fleece by Johns Manville was cut into 3 cm wide strands. A binder was applied onto the fleece by a roller at 40 g/m2 loading level. The fleece with the binder was pressed onto a finished MMVF product that has 145 kg/m3 density with 2500 Pa of pressure and cured at 200 to 225° C. (depending on the binder adhesive used) for 45 minutes. The binder in the MMVF product was according to the invention, was Binder 2 as described above.

After curing of the binder adhesive, the MMVF product was left to cool down for two hours to room temperature and the peel strength was measured. The measurement was done by 90 degrees peel test with Mecmesin force gauge and peel strength is expressed in grams.

This method was carried out for four different binders to bind or adhere the fleece to the MMVF product. The binders were as follows:

Binder 3, according to the invention, which was made as follows:

To 200.0 g lignosulfonate solution (50% solids), 2.5 g NH40H (24.7%) was added and mixed followed by addition by addition of 20.0 g Primid XL552 (100% solids), and 23.0 g PEG 200 (100% solids) and mixing. Finally, 120.3 g water was added and mixed to yield 35% solids and then used for testing the adhesion. This binder was cured at 225° C.

Comparative Binder 1 is as described above (PUF binder). This binder was cured at 200° C.

Comparative Binder 2 is as described above (the lignin based binder). This binder was cured at 225° C.

Comparative Binder 3 is as described above (the formaldehyde free, sugar-based binder). This binder was cured at 225° C.

The results are shown in Table 4. As can be seen from Table 4, when the binder of the invention is used to glue the fleece to the MMVF product, the peel strength is slightly less than PUF, but still acceptable and is improved in comparison to comparative formaldehyde free binders.

TABLE 4

| | | Comparative | Comparative | Comparative |
|---|---|---|---|---|
| | | binder 3 | binder 2 | binder 1 |
| Binder | Binder 3 | (formaldehyde free) | (lignin) | PUF |
| strength, g | 237 | 132 | 233 | 290 |

### Example 5

### Mechanical Strength Studies

### Bar Tests

The mechanical strength of the binders was tested in a bar test. For each binder, 16 bars were manufactured from a mixture of the binder and stone wool shots from the stone wool spinning production.

A sample of this binder solution having 15% dry solid matter (16.0 g) was mixed well with shots (80.0 g). The resulting mixture was then filled into four slots in a heat resistant silicone form for making small bars (4×5 slots per form; slot top dimension: length=5.6 cm, width=2.5 cm; slot bottom dimension: length=5.3 cm, width=2.2 cm; slot height=1.1 cm). The mixtures placed in the slots were then pressed with a suitably sized flat metal bar to generate even bar surfaces. 16 bars from each binder were made in this fashion. The resulting bars were then cured typically at 225° C. The curing time was 1 h. After cooling to room temperature, the bars were carefully taken out of the containers. Five of the bars were aged in a water bath at 80° C. for 3 h. This method of curing the prepared bars was used for example in Tables 1.1, 1.2, 1.4, 1.5, 1.6. Results in Table 1.3 are based on a slightly different method which includes a preconditioning step of 2 h at 90° C., followed by curing for 1 h at 225° C. while the remaining of the procedure is the same.

After drying for 3 days, the aged bars as well as five unaged bars were broken in a 3 point bending test (test speed: 10.0 mm/min; rupture level: 50%; nominal strength: 30 N/mm²; support distance: 40 mm; max deflection 20 mm; nominal e-module 10000 N/mm²) on a Bent Tram machine to investigate their mechanical strengths. The bars were placed with the “top face” up (i.e. the face with the dimensions length=5.6 cm, width=2.5 cm) in the machine.

Binder Example, Reference Binder (Phenol-Formaldehyde Resin Modified with Urea, a PUF-Resol)

This binder is a phenol-formaldehyde resin modified with urea, a PUF-resol.

A phenol-formaldehyde resin is prepared by reacting 37% aq. formaldehyde (606 g) and phenol (189 g) in the presence of 46% aq. potassium hydroxide (25.5 g) at a reaction temperature of 84° C. preceded by a heating rate of approximately 1° C. per minute. The reaction is continued at 84° C. until the acid tolerance of the resin is 4 and most of the phenol is converted. Urea (241 g) is then added and the mixture is cooled.

The acid tolerance (AT) expresses the number of times a given volume of a binder can be diluted with acid without the mixture becoming cloudy (the binder precipitates). Sulfuric acid is used to determine the stop criterion in a binder production and an acid tolerance lower than 4 indicates the end of the binder reaction.

To measure the AT, a titrant is produced from diluting 2.5 ml conc. sulfuric acid (>99%) with 1 L ion exchanged water. 5 mL of the binder to be investigated is then titrated at room temperature with this titrant while keeping the binder in motion by manually shaking it; if preferred, use a magnetic stirrer and a magnetic stick. Titration is continued until a slight cloud appears in the binder, which does not disappear when the binder is shaken.

The acid tolerance (AT) is calculated by dividing the amount of acid used for the titration (mL) with the amount of sample (mL):

$$AT = ( Used titration volume ( mL ) ) / ( Sample volume ( mL ) )$$

Using the urea-modified phenol-formaldehyde resin obtained, a binder is made by addition of 25% aq. ammonia (90 mL) and ammonium sulfate (13.2 g) followed by water (1.30 kg).

The binder solids were then measured as described above and the mixture was diluted with the required amount of water and silane for mechanical measurements (15% binder solids solution, 0.5% silane of binder solids).

### Binder Example, Reference Binder (Binder Based on Alkali Oxidized Lignin)

3267 kg of water is charged in 6000 l reactor followed by 287 kg of ammonia water (24.7%). Then 1531 kg of Lignin UPM BioPiva 100 is slowly added over a period of 30 min to 45 min. The mixture is heated to 40° C. and kept at that temperature for 1 hour. After 1 hour a check is made on insolubilized lignin. This can be made by checking the solution on a glass plate or a Hegman gauge. Insolubilized lignin is seen as small particles in the brown binder. During the dissolution step will the lignin solution change color from brown to shiny black. After the lignin is completely dissolved, 1 liter of a foam dampening agent (Skumdemper 11-10 from NCA-Verodan) is added. Temperature of the batch is maintained at 40° C. Then addition of 307.5 kg 35% hydrogen peroxide is started. The hydrogen peroxide is dosed at a rate of 200-300 l/h. First half of the hydrogen peroxide is added at a rate of 200 I/h where after the dosage rate is increased to 300 l/h.

During the addition of hydrogen peroxide is the temperature in the reaction mixture controlled by heating or cooling in such a way that a final reaction temperature of 65° C. is reached.

The final product was analysed for the COOH group content, dry solid matter, pH, viscosity and remaining H₂O₂·60 g of this oxidized lignin (18.2% solids) was mixed with 1.4 g Primid XL552 (100% solids) and 2.8 g PEG200 (100% solids). 0.6 g Silane (Momentive VS-142 40% activity, 10% in water) and 17.4 g water were added and mixed to yield 15% solids and then used for test of mechanical properties in bar tests.

### Binder Compositions According to the Present Invention

In the following, the entry numbers of the binder example correspond to the entry numbers used in Table 1-1 to 1-6.

The carboxylic acid group content of all lignosulfonates used for the binders according to the present invention was measured using ³¹P NMR and was found to be in the range of 0.05 to 0.6 mmol/g, based on the dry weight of the lignosulfonate lignins, for all examples.

### Example 2

To 30.0 g lignosulfonate solution (50% solids), 0.4 g NH40H (24.7%) was added and mixed followed by addition of 1.9 g Primid XL552 (100% solids) and mixing. Finally, 0.7 g Silane (Momentive VS-142 40% activity, 10% in water) and 64.3 g water were added and mixed to yield 15% solids and then used for test of mechanical properties in bar tests.

### Example 11

To 30.0 g lignosulfonate solution (50% solids), 0.4 g NH40H (24.7%) was added and mixed followed by addition of 2.1 g Primid XL552 (100% solids) and 3.4 g PEG 200 (100% solids) and mixing. Finally, 0.7 g Silane (Momentive VS-142 40% activity, 10% in water) and 61.8 g water were added and mixed to yield 15% solids and then used for test of mechanical properties in bar tests.

### Example 15

To 30.0 g lignosulfonate solution (50% solids), 0.4 g NH40H (24.7%) was added and mixed followed by addition of 2.9 g Primid XL552 (100% solids) and 3.4 g PEG 200 (100% solids) and mixing. Finally, 0.8 g Silane (Momentive VS-142 40% activity, 10% in water) and 67 g water were added and mixed to yield 15% solids and then used for test of mechanical properties in bar tests.

### Example 30

To 30.0 g lignosulfonate solution (50% solids), 0.4 g NH₄OH (24.7%) was added and mixed followed by addition of 2.9 g Primid XL552 (100% solids) and 3.4 g 1,1,1 tris(hydroxymethyl)propane (100% solids) and mixing. Finally, 0.8 g Silane (Momentive VS-142 40% activity, 10% in water) and 67 g water were added and mixed to yield 15% solids and then used for test of mechanical properties in bar tests.

### Example 33

To 100.0 g lignosulfonate solution (50% solids), 0.3 g KOH in pellet form was added and mixed followed by addition of 10.8 g Primid XL552 (100% solids) and 11.3 g PEG 200 (100% solids) and mixing. Finally, 2.6 g Silane (Momentive VS-142 40% activity, 10% in water) and 228 g water were added and mixed to yield 15% solids and then used for test of mechanical properties in bar tests.

### Example 41

To 30.0 g lignosulfonate solution (50% solids), 0.4 g NH40H (24.7%) was added and mixed followed by addition of 1.9 g Primid XL552 (100% solids) and 1.7 g PEG 200 (100% solids) and 1.7 g urea (100% solids) and mixing. Finally, 0.7 g Silane (Momentive VS-142 40% activity, 10% in water) and 60.5 g water were added and mixed to yield 15% solids and then used for test of mechanical properties in bar tests.

Mechanical properties are presented in Tables 1.1-1.6. Further example binder compositions were prepared, as shown in Tables 1.1 to 1.6. For simplicity, quantities of all other components are recalculated based on 100 g of dry lignin.

As can be seen from Table 1.1 a combination of crosslinker (Primid XL 552) and plasticizer (PEG 200) is required to achieve high mechanical properties (unaged and aged strength in bar test) that are at comparable level to reference binder (11 and 15 versus 2 and 9 versus reference binder).

Table 1.2 and 1.3 show that different plasticizers can be used (13 and 15 versus 30) or combination of plasticizers (34 versus 41) and that the PEG 200 is a preferred plasticizer.

Table 1.4 shows that addition of silane can help achieve aged strength on the same level as reference binders.

Table 1.5 shows that the binder has high strength without the presence of a base but that a non-permanent base (NH₄OH) or a permanent base (KOH) can be added to the formulation to protect the production equipment from corrosion without significant changes in strength.

Table 1.6 shows that different lignosulfonates can be used.

This overall means, we are able to produce a MMVF product based on a phenol-free and formaldehyde-free binder composition with a high content of renewable material based on lignin, which has comparable mechanical properties to the reference systems and can be produced in a simpler and less expensive way.

TABLE 1.1

| | Reference binder | Reference binder | | | | | | | |
|---|---|---|---|---|---|---|---|---|---|
| | (Phenol-formaldehyde | (binder based | | | | | | | |
| | resin modified with | on alkali | | | | | | | |
| | urea, a PUF-resol) | oxidized lignin) | 1 | 2 | 8 | 9 | 10 | 11 | 15 |
| Binder composition | | | | | | | | | |
| ammonium lignosulfonate (g dry lignin) | | | 100 | 100 | 100 | 100 | 100 | 100 | 100 |
| ammonium calcium lignosulfonate (g | | | | | | | | | |
| dry lignin) | | | | | | | | | |
| PEG 200 (g) | | | 0 | 0 | 23 | 40 | 23 | 23 | 23 |
| 1,1,1 tris(hydroxymethyl)propane (g) | | | | | | | | | |
| urea (g) | | | | | | | | | |
| NH4OH (g) | | | 0.8 | 0.8 | 0.8 | 0.8 | 0.8 | 0.8 | 0.8 |
| KOH (g) | | | | | | | | | |
| Primid XL552 (g) | | | 0 | 14 | 0 | 10 | 7 | 14 | 20 |
| Momentive VS 142 (% of binder solids), | | | 0.5 | 0.5 | 0.5 | 0.5 | 0.5 | 0.5 | 0.5 |
| based on 40% activity | | | | | | | | | |
| Binder properties | | | | | | | | | |
| Mechanical strength, unaged (N), bars | 350 | 270 | 60 | 280 | 70 | 150 | 110 | 230 | 320 |
| tests | | | | | | | | | |
| Mechanical strength, aged (N), bar | 150 | 130 | 0 | 50 | 20 | 40 | 50 | 140 | 130 |
| tests | | | | | | | | | |
| Curing temp, ° C. | 200 | 225 | 225 | 225 | 225 | 225 | 225 | 225 | 225 |

TABLE 1.2

| | 12 | 13 | 15 | 26 | 27 | 28 | 29 | 30 |
|---|---|---|---|---|---|---|---|---|
| Binder composition | | | | | | | | |
| ammonium lignosulfonate (g dry lignin) | 100 | 100 | 100 | 100 | 100 | 100 | 100 | 100 |
| ammonium calcium lignosulfonate (g dry lignin) | | | | | | | | |
| PEG 200 (g) | 23 | 23 | 23 | | | | | |
| 1,1,1 tris(hydroxymethyl)propane (g) | | | | 23 | 23 | 40 | 23 | 23 |
| urea (g) | | | | | | | | |
| Primid XL552 (g) | 13 | 13 | 20 | 0 | 0 | 0 | 20 | 20 |
| NH4OH (g) | 0.8 | 0.8 | 0.8 | 0.8 | 0.8 | 0.8 | 0.8 | 0.8 |
| KOH (g) | | | | | | | | |
| Momentive VS 142 (% of binder solids), based on 40% activity | 0 | 0.5 | 0.5 | 0 | 0.5 | 0.5 | 0 | 0.5 |
| Binder properties | | | | | | | | |
| Mechanical strength, unaged (N), bars tests | 250 | 250 | 320 | 80 | 90 | 90 | 200 | 210 |
| Mechanical strength, aged (N), bar tests | 30 | 110 | 130 | 10 | 10 | 20 | 60 | 100 |
| Curing temp, ° C. | 225 | 225 | 225 | 225 | 225 | 225 | 225 | 225 |

TABLE 1.3

| | 34 | 36 | 39 | 40 | 41 |
|---|---|---|---|---|---|
| Binder composition | | | | | |
| ammonium lignosulfonate | 100 | 100 | 100 | 100 | 100 |
| (g dry lignin) | | | | | |
| ammonium calcium lignosulfonate | | | | | |
| (g dry lignin) | | | | | |
| PEG 200 (g) | 23 | 12 | 4.5 | 0 | 12 |
| 1,1,1 tris(hydroxymethyl)propane (g) | | | | | |
| urea (g) | | | | | 12 |
| Primid XL552 (g) | 13 | 13 | 13 | 13 | 13 |
| NH4OH (g) | 0.8 | 0.8 | 0.8 | 0.8 | 0.8 |
| KOH (g) | | | | | |
| Momentive VS 142 (% of binder | 0.5 | 0.5 | 0.5 | 0.5 | 0.5 |
| solids), based on 40% activity | | | | | |
| Binder properties | | | | | |
| Mechanical strength, unaged (N), | 150 | 150 | 140 | 60 | 135 |
| bars tests | | | | | |
| Mechanical strength, aged (N), | 60 | 50 | 40 | 20 | 40 |
| bar tests | | | | | |
| Curing temp, ° C. | 225 | 225 | 225 | 225 | 225 |

TABLE 1.4

| | 12 | 13 | 14 | 15 | 29 | 30 |
|---|---|---|---|---|---|---|
| Binder composition | | | | | | |
| ammonium lignosulfonate (g dry lignin) | 100 | 100 | 100 | 100 | 100 | 100 |
| ammonium calcium lignosulfonate (g dry lignin) | | | | | | |
| PEG 200 (g) | 23 | 23 | 23 | 23 | | |
| 1,1,1 tris(hydroxymethyl)propane (g) | | | | | 23 | 23 |
| urea (g) | | | | | | |
| Primid XL552 (g) | 13 | 13 | 20 | 20 | 20 | 20 |
| NH4OH (g) | 0.8 | 0.8 | 0.8 | 0.8 | 0.8 | 0.8 |
| KOH (g) | | | | | | |
| Momentive VS 142 (% of binder solids), based on 40% activity | 0 | 0.5 | 0 | 0.5 | 0 | 0.5 |
| Binder properties | | | | | | |
| Mechanical strength, unaged (N), bars tests | 250 | 250 | 380 | 320 | 200 | 210 |
| Mechanical strength, aged (N), bar tests | 30 | 110 | 40 | 130 | 60 | 100 |
| Curing temp, ° C. | 225 | 225 | 225 | 225 | 225 | 225 |

TABLE 1.5

| | 31 | 32 | 33 |
|---|---|---|---|
| Binder composition | | | |
| ammonium lignosulfonate (g dry lignin) | 100 | 100 | 100 |
| ammonium calcium lignosulfonate (g dry lignin) | | | |
| PEG 200 (g) | 23 | 23 | 23 |
| 1,1,1 tris(hydroxymethyl)propane (g) | | | |
| urea (g) | | | |
| Primid XL552 (g) | 22 | 22 | 22 |
| NH4OH (g) | 0 | 1.0 | 0 |
| KOH (g) | 0 | 0 | 0.6 |
| Momentive VS 142 (% of binder solids), | 0.5 | 0.5 | 0.5 |
| based on 40% activity | | | |
| Binder properties | | | |
| Mechanical strength, unaged (N), bars tests | 330 | 300 | 290 |
| Mechanical strength, aged (N), bar tests | 160 | 120 | 130 |
| Curing temp, ° C. | 225 | 225 | 225 |

TABLE 1.6

| | 11 | 15 | 45 | 46 |
|---|---|---|---|---|
| Binder composition | | | | |
| ammonium lignosulfonate | 100 | 100 | | |
| (g dry lignin) | | | | |
| ammonium calcium lignosulfonate | | | 100 | 100 |
| (g dry lignin) | | | | |
| PEG 200 (g) | 23 | 23 | 23 | 23 |
| 1,1,1 tris(hydroxymethyl)propane (g) | | | | |
| urea (g) | | | | |
| Primid XL552 (g) | 13 | 20 | 13 | 20 |
| NH4OH (g) | 0.8 | 0.8 | 0.8 | 0.8 |
| KOH (g) | | | | |
| Momentive VS 142 (% of binder | 0.5 | 0.5 | 0.5 | 0.5 |
| solids), based on 40% activity | | | | |
| Binder properties | | | | |
| Mechanical strength, unaged (N), | 230 | 320 | 210 | 300 |
| bar tests | | | | |
| Mechanical strength, aged (N), | 140 | 130 | 120 | 130 |
| bar tests | | | | |
| Curing temp, ° C. | 225 | 225 | 225 | 225 |

### Examples 47-54

In the following, the entry numbers of the binder example correspond to the entry numbers used in Table 2.1.

The carboxylic acid group content of all lignosulfonates used for the binders according to the present invention was measured using 31 P NMR and was found to be in the range of 0.05 to 0.6 mmol/g, based on the dry weight of the lignosulfonate lignins, while it was found for this specific batch used for examples 47, 48, 49, 50, 51, 52, 53, 54 to be 0.14 mmol/g.

### Example 47

To 30.0 g lignosulfonate solution (50% solids), 0.4 g NH40H (24.7%) was added and mixed followed by addition of 0.7 g Silane (Momentive VS-142 40% activity, 10% in water) and 68.9 g water were added and mixed to yield 15% solids and then used for test of mechanical properties in bar tests.

### Example 49

To 30.0 g lignosulfonate solution (50% solids), 0.4 g NH40H (24.7%) was added and mixed followed by addition of 6.0 g Primid XL552 (100% solids) and mixing. Finally, 1.0 g Silane (Momentive VS-142 40% activity, 10% in water) and 102.6 g water were added and mixed to yield 15% solids and then used for test of mechanical properties in bar tests.

Mechanical properties are presented in Table 2.1. Further example binder compositions were prepared, as shown in Table 2.1.

For simplicity, quantities of all other components are recalculated based on 100 g of dry lignin.

As can be seen from Table 2.1, in a combination of lignosulfonate and crosslinker (Primid XL 552) higher amounts of crosslinker lead to better mechanical properties.

TABLE 2.1

| | PUF ref | 47 | 48 | 49 | 50 |
|---|---|---|---|---|---|
| Binder composition | | | | | |
| ammonium lignosulfonate | | 100 | 100 | 100 | 100 |
| (g solids) | | | | | |
| PEG 200 (g) | | 0 | 0 | 0 | 0 |
| urea (g) | | | | | |
| ammonia, 24.7% (g) | | 2.5 | 2.5 | 2.5 | 2.5 |
| Primid XL552 (g) | | 0 | 25 | 40 | 60 |
| Momentive VS 142 (% of binder | | 0.5 | 0.5 | 0.5 | 0.5 |
| solids), based on 40% activity | | | | | |
| Binder properties | | | | | |
| Mechanical strength, unaged (N), | 350 | 60 | 280 | 460 | 640 |
| bars tests | | | | | |
| Mechanical strength, aged (N), | 150 | 0 | 160 | 180 | 230 |
| bar tests | | | | | |
| Curing temp, ° C. | 200 | 225 | 225 | 225 | 225 |

### Example 53: Test of Stone Wool Products

The low density products have been examined for properties according to the product standard for Factory made mineral wool (MW) products, DS/EN13162:2012+A1:2015, meaning relevant mechanical properties besides other basic characteristics for stone wool products.

The testing has been performed on slabs, where test specimens according to the dimensional specifications and to the number of test specimens required to get one test result, as stated in EN13162 for each of the different test methods, has been cut out. Each of the stated values for the mechanical properties obtained is an average of more results according to EN13162.

Tests are performed on products or test specimens sampled directly from the production line before packing (line cuts) and/or for products or test specimens sampled from packs 24 hours after packing (24 h packs).

### Dimensions

Dimensions of products and test specimens has been performed according to the relevant test methods, DS/EN822:2013: Thermal insulating products for building applications—Determination of length and width, and DS/EN823:2013: Thermal insulating products for building applications—Determination of thickness.

### Binder Content (Loss On Ignition)

Determination of binder content is performed according to DS/EN13820:2003: Thermal insulating materials for building applications—Determination of organic content, where the binder content is defined as the quantity of organic material burnt away at a given temperature, stated in the standard to be (500±20° C.). In the testing the temperature (590±20° C., for at least 10 min or more until constant mass) has been used in order to make sure that all organic material is burnt away. Determination of ignition loss consists of at least 10 g wool corresponding to 8-20 cut-outs (minimum 8 cut-outs) performed evenly distributed over the test specimen using a cork borer ensuring to comprise an entire product thickness. The binder content is taken as the LOI. The binder includes binder additives.

### Tensile Strength

The tensile strength of low density products has been determined according to EN 1608:2013: Thermal insulating products for building applications—Determination of tensile strength parallel to faces. The tensile strength is measured on test specimens from line cuts and on test specimens from 24 h packs.

Self-Deflection (f70)

Self-deflection is measured according to an internal test method for determining the deflection caused by the net weight of a product. A test-specimen of length: 990±10 mm and width: min. 270±5 mm and max 680±5 mm is placed horizontally on two supports (tilting table) with a mutual centre distance of (700±2) mm and two moveable supporting devices. The self-deflection is measured in the middle of the specimen and recorded either mechanically or electrically (transducer with display) and read either on a scale or a digital display. If the original product is longer than 990±10 mm the extra length is cut off. The self-deflection is measured on both surfaces of the test specimen. The accuracy of measurement is ±0.2 mm for self-deflection <10 mm and ±1 mm for self-deflection >10 mm).

The self-deflection is reported as (f70, 70 cm span)=(f1+f2)/2 mm, where f1 is the measurement with surface 1 facing up and f2 is the measurement with surface 2 facing up.

Testing is performed on test specimens from line cuts and on test specimens from 24 h packs.

### Example 53

The stone wool product has been produced by use of binder in example 53, at a curing oven temperature set to 275° C.

609.0 kg of ammonium lignosulfonate was placed in a mixing vessel to which 8 l NH40H (24.7%) was added and stirred. Afterwards, 384 kg Primid XL552 solution (pre-made 31 wt % solution in water) was added and mixed followed by addition of 14 kg Silane (Momentive VS-142 40% activity, 10% in water).

The binder from this example is used to produce a low density stone wool product, thickness and density were measured as indicated in Table 3.1. Curing oven temperature was set to 275° C.

### Example 54

The stone wool product has been produced by use of binder in example 54, at a curing oven temperature set to 255° C.

730.0 kg of ammonium lignosulfonate was placed in a mixing vessel to which 8.5 l NH40H (24.7%) was added and stirred. Afterwards, 151 kg Primid XL552 solution (pre-made 31 wt % solution in water) and 43 kg PEG 200 (100% solids) were added and mixed followed by addition of 13 kg Silane (Momentive VS-142 40% activity, 10% in water).

The binder from this example is used to produce a high density stone wool product, 100 mm thickness, 145 kg/m³ density, wherein the product has a loss on ignition (LOI) of 3.5 wt %. Curing oven temperature was set to 255° C.

TABLE 3.1

| | Tensile strength, crosswise - packs | | | | Tensile strength, crosswise - line cuts | | | | |
|---|---|---|---|---|---|---|---|---|---|
| | | Ignition | Self | Sample | Sigma | Ignition | | Sample | Sigma |
| | Thickness | loss | deflection f(70) | density | (t) | loss | Thickness | density | (t) |
| Example | mm | % | mm | kg/m3 | kPa | % | mm | kg/m3 | kPa |
| PUF-reference | 145 | 2.82 | 7.2 | 32.3 | 7.6 | 2.50 | 153 | 31.0 | 10.2 |
| 53 | 139 | 2.81 | 8.9 | 34.3 | 6.7 | 2.54 | 158 | 30.7 | 8.7 |

1. A sports field comprising:
(i) a lower base layer;
(ii) an upper grass and/or artificial grass layer;
(iii) a shock pad layer, positioned between the base layer and the grass and/or artificial grass layer;
wherein the shock pad layer comprises at least one shock pad comprising a coherent plate having upper and lower major surfaces, wherein the coherent plate comprises at least one coherent layer comprising man-made vitreous fibres (MMVF) bonded with a cured aqueous binder composition free of phenol and formaldehyde; wherein the aqueous binder composition prior to curing comprises:
a component (i) in form of one or more lignosulfonate lignins having a carboxylic acid group content of 0.03 to 1.4 mmol/g, based on the dry weight of the lignosulfonate lignins,
a component (ii) in form of one or more cross-linkers.

2. The sports field according to claim 1, wherein the aqueous binder composition further comprises a component (iii) in form of one or more plasticizers.

3. The sports field according to claim 1, with the proviso that the aqueous binder composition does not comprise a cross-linker selected from:
epoxy compounds having a molecular weight Mw of 500 or less
carbonyl compounds selected from aldehydes, carbonyl compounds of the formula R—[C(O)R₁]ₓ in which:
R represents a saturated or unsaturated and linear, branched or cyclic hydrocarbon radical, a radical including one or more aromatic nuclei which consist of 5 or 6 carbon atoms, a radical including one or more aromatic heterocycles containing 4 or 5 carbon atoms and an oxygen, nitrogen or sulfur atom, it being possible for the R radical to contain other functional groups, R₁ represents a hydrogen atom or a C₁-C₁₀ alkyl radical, and x varies from 1 to 10,
polyamines.

4. The sports field according to claim 1, wherein component (i) is having a carboxylic acid group content of 0.05 to 0.6 mmol/g, based on the dry weight of lignosulfonate lignins.

5. The sports field according to claim 1, wherein component (i) is in form of one or more lignosulfonate lignins having an average carboxylic acid group content of less than 1.8 groups per macromolecule considering the M_n wt. average of component (i), such as less than 1.4 such as less than 1.1 such as less than 0.7 such as less than 0.4.

6. The sports field according to claim 1, wherein component (i) is having a content of phenolic OH groups of 0.3 to 2.5 mmol/g, such as 0.5 to 2.0 mmol/g, such as 0.5 to 1.5 mmol/g. based on the dry weight of lignosulfonate lignins.

7. The sports field according to claim 1, wherein component (i) is having a content of aliphatic OH groups of 1.0 to 8.0 mmol/g, such as 1.5 to 6.0 mmol/g, such as 2.0 to 5.0 mmol/g, based on the dry weight of lignosulfonate lignins.

8. The sports field according to claim 1, wherein the component (i) comprises ammoniumlignosulfonates and/or calciumlignosulfonates, and/or magnesiumlignosulfonates, and any combinations thereof.

9. The sports field according to claim 1, wherein component (i) comprises ammoniumlignosulfonates and calciumlignosulfonates, wherein the molar ratio of NH₄⁺ to Ca²⁺ is in the range of 5:1 to 1:5, in particular 3:1 to 1:3.

10. The sports field according to claim 1, wherein the aqueous binder composition contains added sugar in an amount of 0 to less than 5 wt.-%, based on the weight of lignosulfonate and sugar.

11. The sports field according to claim 1, wherein the aqueous binder composition comprises component (i) in an amount of 50 to 98 wt.-%, such as 65 to 98 wt.-%, such as 80 to 98 wt.-%, based on the dry weight of components (i) and (ii).

12. The sports field according to claim 1, wherein the component (ii) is in form of one or more cross-linkers selected from;
β-hydroxyalkylamide-cross-linkers, and/or
oxazoline-cross-linkers, and/or
the group consisting of multifunctional organic amines such as an alkanolamine, diamines, such as hexamethyldiamine, and/or
epoxy compounds having a molecular weight of more than 500, such as an epoxidised oil based on fatty acid triglyceride or one or more flexible oligomer or polymer, such as a low Tg acrylic based polymer, such as a low Tg vinyl based polymer, such as low Tg polyether, which contains reactive functional groups such as carbodiimide groups, such as anhydride groups, such as oxazoline groups, such as amino groups, such as epoxy groups, and/or
one or more cross-linkers selected from the group consisting of fatty amines; and/or
one more cross-linkers in form of fatty amides; and/or
one or more cross-linkers selected from polyester polyols, such as polycaprolactone; and/or
one or more cross-linkers selected from the group consisting of starch, modified starch, CMC; and/or
one or more cross-linkers in form of multifunctional carbodiimides, such as aliphatic multifunctional carbodiimides; and/or
one or more cross-linkers selected from melamine based cross-linkers, such as a hexakis(methylmethoxy)melamine (HMMM) based cross-linkers.

13. The sports field according to claim 1, wherein the component (ii) comprises one or more cross-linkers selected from β-hydroxyalkylamide-cross-linkers and/or oxazoline-cross-linkers.

14. The sports field according to claim 1, comprising component (ii) in an amount of 1 to 50 wt.-%, such as 4 to 20 wt.-%, such as 6 to 12 wt.-%, based on the dry weight of component (i).

15. The sports field according to claim 1, wherein the component (ii) is in form of one or more cross-linkers selected from;
β-hydroxyalkylamide-cross-linkers, such as N-(2-hydroxyisopropyl)amide-cross-linkers, such as N-(2-hydroxyethyl)amide-cross-linkers, such as N-(2-hydroxyethyl)adipamide-cross-linkers, such as N,N,N′,N′-tetrakis(2-hydroxyethyl)adipamide and/or
the group consisting of multifunctional organic amines such as an alkanolamine, diamines, such as hexamethyldiamine, and/or
epoxy compounds having a molecular weight of more than 500, such as an epoxidised oil based on fatty acid triglyceride or one or more flexible oligomer or polymer, such as a low Tg acrylic based polymer, such as a low Tg vinyl based polymer, such as low Tg polyether, which contains reactive functional groups such as carbodiimide groups, such as anhydride groups, such as oxazoline groups, such as amino groups, such as epoxy groups, and/or
one or more cross-linkers in form of multifunctional carbodiimides, such as aliphatic multifunctional carbodiimides.

16. The sports field according to claim 1, wherein the component (ii) comprises one or more cross-linkers selected from β-hydroxyalkylamide-cross-linkers, such as N-(2-hydroxyisopropyl)amide-cross-linkers, such as N-(2-hydroxyethyl)amide-cross-linkers, such as N-(2-hydroxyethyl)adipamide-cross-linkers, such as N,N,N′,N′-tetrakis(2-hydroxyethyl)adipamide.

17. The sports field according to claim 1, comprising component (ii) in an amount of 2 to 90 wt.-%, such as 6 to 60 wt.-%, such as 10 to 40 wt.-%, such as 25 to 40 wt.-%, based on the dry weight of component (i).

18. The sports field according to claim 2, wherein component (iii) is in form of:
one or more plasticizers selected from the group consisting of fatty alcohols, monohydroxy alcohols, such as pentanol, stearyl alcohol; and/or
one or more plasticizers selected from the group consisting of alkoxylates such as ethoxylates, such as butanol ethoxylates, such as butoxytriglycol; and/or
one or more plasticizers in form of propylene glycols; and/or
one or more plasticizers in form of glycol esters; and/or
one or more plasticizers selected from the group consisting of adipates, acetates, benzoates, cyclobenzoates, citrates, stearates, sorbates, sebacates, azelates, butyrates, valerates; and/or
one or more plasticizers selected from the group consisting of phenol derivatives, such as alkyl or aryl substituted phenols; and/or
one or more plasticizers selected from the group consisting of silanols, siloxanes; and/or
one or more plasticizers selected from the group consisting of sulfates such as alkyl sulfates, sulfonates such as alkyl aryl sulfonates such as alkyl sulfonates, phosphates such as tripolyphosphates; and/or
one or more plasticizers in form of hydroxy acids; and/or
one or more plasticizers selected from the group consisting of monomeric amides, such as acetamides, benzamide, fatty acid amides such as tall oil amides; and/or
one or more plasticizers selected from the group consisting of quaternary ammonium compounds such as trimethylglycine, distearyldimethylammoniumchloride; and/or
one or more plasticizers selected from the group consisting of vegetable oils such as castor oil, palm oil, linseed oil, soybean oil; and/or
tall oil, and/or
one or more plasticizers selected from the group consisting of hydrogenated oils, acetylated oils; and/or
one or more plasticizers selected from acid methyl esters; and/or
one or more plasticizers selected from the group consisting of alkyl polyglucosides, gluconamides, aminoglucoseamides, sucrose esters, sorbitan esters; and/or
one or more plasticizers selected from the group consisting of polyethylene glycols, polyethylene glycol ethers; and/or
one or more plasticizers in form of polyols, such as glycerol, such as 1,1,1-Tris(hydroxymethyl)propane; and/or
triethanolamine.

19. The sports field according to claim 2, wherein component (iii) is in form of propylene glycols, phenol derivatives, silanols, siloxanes, hydroxy acids, vegetable oils, polyethylene glycols, polyethylene glycol ethers, triethanolamine, or any mixtures thereof.

20. The sports field according to claim 2, wherein component (iii) comprises one or more plasticizers having a boiling point of 100 to 380° C., more preferred 120 to 300° C., more preferred 140 to 250° C.

21. The sports field according to claim 2, wherein component (iii) comprises one or more polyethylene glycols having an average molecular weight of 150 to 50000 g/mol, in particular 150 to 4000 g/mol, more particular 150 to 1000 g/mol, preferably 150 to 500 g/mol, more preferably 200 to 400 g/mol.

22. The sports field according to claim 2, wherein the component (iii) is present in an amount of 0.5 to 60, preferably 2.5 to 25, more preferably 3 to 15 wt.-%, based on the dry weight of component (i).

23. The sports field according to claim 2, wherein the aqueous binder composition comprises a further component (iv) in form of one or more coupling agents, such as organofunctional silanes.

24. The sports field according to claim 1, wherein the aqueous binder composition comprises a component (v) in form of one or more components selected from the group of bases, such as ammonia, such as alkali metal hydroxides, such as KOH, such as earth alkaline metal hydroxides, such as Ca(OH)₂, such as Mg(OH)₂, such as amines or any salts thereof.

25. The sports field according to claim 2, wherein the aqueous binder composition comprises a further component in form of urea, in particular in an amount 5 to 40 wt.-%, such as 10 to 30 wt.-%, such as 15 to 25 wt.-%, based on the dry weight of component (i).

26. The sports field according to claim 2, wherein the at least one coherent layer does not contain an ammonia-oxidized lignin (AOL).

27. The sports field according to claim 2, wherein the shock pad further comprises: an upper membrane layer bonded to the upper major surface of the coherent plate; and/or a lower membrane layer bonded to the lower major surface of the coherent plate.

28. The sports field according to claim 2, wherein the at least one coherent layer has a thickness in the range of 12 mm to 60 mm, preferably 15 mm to 40 mm, more preferably 20 mm to 35 mm, most preferably 23 mm to 30 mm.

29. The sports field according to claim 2, wherein the at least one coherent layer has a density in the range of 175 kg/m³ to 300 kg/m³, preferably 220 kg/m³ to 280 kg/m³, more preferably of 275 kg/m³.

30. The sports field according to claim 2, wherein the at least one coherent layer has a hydraulic conductivity of 5 m/day to 200 m/day, preferably 10 m/day to 50 m/day and/or a contact angle with water of less than 90°.

31. The sports field according to claim 2, wherein the at least one coherent layer comprises MMVF having a geometric fibre diameter of 1.5 to 10 microns, preferably 2 to 8 microns, more preferably 2 to 5 microns.

32. The sports field according to claim 2, wherein the at least one coherent layer does not comprise any wetting agent.

33. The sports field according to claim 1, further comprising (iv) an infill layer between the shock pad layer and the grass and/or artificial grass layer or in the grass and/or artificial grass layer, wherein the infill layer comprises sand or non-plastic material.

34. A method of producing a sports field, comprising the steps of:
(i) providing a lower base layer;
(ii) providing a shock pad layer above the base layer;
(iii) providing an upper grass and/or artificial grass layer above the shock pad layer;
wherein the shock pad layer comprises at least one shock pad comprising a coherent plate having upper and lower major surfaces, wherein the coherent plate comprises at least one coherent layer comprising man-made vitreous fibres (MMVF) bonded with a cured aqueous binder composition free of phenol and formaldehyde; wherein the aqueous binder composition prior to curing comprises:
a component (i) in form of one or more lignosulfonate lignins having a carboxylic acid group content of 0.03 to 1.4 mmol/g, based on the dry weight of the lignosulfonate lignins,
a component (ii) in form of one or more cross-linkers.

35. The method according to claim 34, further comprising providing an infill layer between the shock pad layer and the upper grass or artificial grass layer, wherein the infill layer comprises sand or non-plastic material.

36. A shock pad comprising a coherent plate having upper and lower major surfaces, wherein the coherent plate comprises at least one coherent layer comprising man-made vitreous fibres (MMVF) bonded with a cured aqueous binder composition free of phenol and formaldehyde; wherein the aqueous binder composition prior to curing comprises:
a component (i) in form of one or more lignosulfonate lignins having a carboxylic acid group content of 0.03 to 1.4 mmol/g, based on the dry weight of the lignosulfonate lignins,
a component (ii) in form of one or more cross-linkers.

37. The shock pad according to claim 36, wherein the aqeuous binder composition prior to curing further comprises a component (iii) in form of one or more plasticizers.

38. A method of producing a shock pad comprising the steps of:
(i) providing man-made vitreous fibres;
(ii) spraying the man-made vitreous fibres with an aqueous binder composition free of phenol and formaldehyde;
(iii) collecting and consolidating the man-made vitreous fibres and curing the aqueous binder composition to form a coherent layer;
(iv) providing a coherent plate having upper and lower major surfaces, wherein the coherent plate comprises at least one coherent layer;
wherein the aqueous binder composition prior to curing comprises:
a component (i) in form of one or more lignosulfonate lignins having a carboxylic acid group content of 0.03 to 1.4 mmol/g, based on the dry weight of the lignosulfonate lignins,
a component (ii) in form of one or more cross-linkers.

39. A method of using a shock pad to provide a shock-absorbing surface in a sports field, comprising the step of: positioning a shock pad or an array of shock pads beneath the surface of a sports field, wherein the shock pad comprises: a coherent plate having upper and lower major surfaces, wherein the coherent plate comprises at least one coherent layer comprising man-made vitreous fibres (MMVF) bonded with a cured aqueous binder composition free of phenol and formaldehyde; wherein the aqueous binder composition prior to curing comprises:
a component (i) in form of one or more lignosulfonate lignins having a carboxylic acid group content of 0.03 to 1.4 mmol/g, based on the dry weight of the lignosulfonate lignins,
a component (ii) in form of one or more cross-linkers.

40. Use of a shock pad for absorbing shock in a sports field, wherein the shockpad comprises: a coherent plate having upper and lower major surfaces, wherein the coherent plate comprises at least one coherent layer comprising man-made vitreous fibres (MMVF) bonded with a cured aqueous binder composition free of phenol and formaldehyde; wherein the aqueous binder composition prior to curing comprises:
a component (i) in form of one or more lignosulfonate lignins having a carboxylic acid group content of 0.03 to 1.4 mmol/g, based on the dry weight of the lignosulfonate lignins,
a component (ii) in form of one or more cross-linkers.

41. Use of a shock pad for absorbing and/or draining water in a sports field, wherein the shock pad comprises: a coherent plate having upper and lower major surfaces, wherein the coherent plate comprises at least one coherent layer comprising man-made vitreous fibres (MMVF) bonded with a cured aqueous binder composition free of phenol and formaldehyde;
wherein the aqueous binder composition prior to curing comprises:
a component (i) in form of one or more lignosulfonate lignins having a carboxylic acid group content of 0.03 to 1.4 mmol/g, based on the dry weight of the lignosulfonate lignins,
a component (ii) in form of one or more cross-linkers.

42. Use of a shock pad for cooling the surface temperature of a sports field, wherein the shock pad comprises: a coherent plate having upper and lower major surfaces, wherein the coherent plate comprises at least one coherent layer comprising man-made vitreous fibres (MMVF) bonded with a cured aqueous binder composition free of phenol and formaldehyde; wherein the aqueous binder composition prior to curing comprises:
a component (i) in form of one or more lignosulfonate lignins having a carboxylic acid group content of 0.03 to 1.4 mmol/g, based on the dry weight of the lignosulfonate lignins,
a component (ii) in form of one or more cross-linkers.

43. Use of a lignin component in form of one or more lignosulfonate lignins having a carboxylic acid group content of 0.03 to 1.4 mmol/g, based on the dry weight of the lignosulfonate lignins, for the preparation of a binder composition free of phenol and formaldehyde for a coherent plate of a shock pad comprising man-made vitreous fibres (MMVF) bonded.
